(19) United States
(12) Patent Application Publication
(10) Pub. No.: US 2016/0328406 A1
(43) Pub. Date: Nov. 10, 2016

(54) INTERACTIVE RECOMMENDATION OF DATA SETS FOR DATA ANALYSIS

(71) Applicant: Informatica LLC, Redwood City, CA (US)

(72) Inventors: Gregorio Convertino, Sunnyvale, CA (US); Abhiram Gujjewar, San Ramon, CA (US); Firoz Kanchwala, Belmont, CA (US)

(21) Appl. No.: 15/150,296

(22) Filed: May 9, 2016

Related U.S. Application Data
(60) Provisional application No. 62/159,178, filed on May 8, 2015.

(51) Int. Cl. G06F 17/30; G06F 3/0482; G06F 3/0484

(52) U.S. Cl. CPC G06F 17/3053; G06F 17/30867; G06F 17/30528; G06F 17/30554; G06F 3/04842; G06F 3/0482

(57) ABSTRACT

A data analysis platform provides recommendations for datasets for analysis. Given a user selected dataset, for example resulting from a search,
automatically identifies other datasets based a variety of different types of relationships, including lineage, structural, content, usage, classification, and organizational/social. Datasets for each type of relationship are identified and scored for relevance, and ranked. Selected ones of the ranked data sets are presented in a recommendation interface. As the user selects from recommended dataset, additional datasets are automatically recommended based in inferences made according to the selected dataset and relationship.

### RELATED APPLICATIONS

This application claims priority to of U.S. Provisional Application No. 62/159,178, filed May 8, 2015 which is incorporated by reference in its entirety.

### 1. FIELD OF DISCLOSURE

The disclosure generally relates to systems and platforms for data analysis using interactive recommendations of data sets by matching characteristic patterns of one data set with one or more characteristic patterns of a candidate data set.

FIELDS OF CLASSIFICATION: 707/767, 707/6 (999.006), 707/758.

### 2. BACKGROUND INFORMATION

Data analysis platforms are applications used by data analysts and data scientists. Data analysts and data scientists need to deliver timely studies (i.e., data analyses) to answer numerous business questions from their business customers. The problem can be summarized as follows: too many potentially relevant datasets are available while, on the other end (the user end), there is little support for finding the actually relevant datasets and, on the system end, there is little or no information about the intent of the user in the analysis.

More specifically, these users are not adequately supported because in the current applications, finding data is slow. Data analysts and data scientists spend more time finding and preparing the data than performing actual analysis. In addition, data is not easily visible to the users if useful data is available, i.e., they find it hard to identify what data is suitable for the current study either as raw data to be prepared or as already prepared and fit for purpose. There also tends to be a lack of reuse of data among analysts. They cannot easily reuse the analyses already done by others: i.e., the datasets already prepared by others or prepared by the same analyst in the past.

Further issues are caused by inconsistencies among analysts. Since data analysts and data scientists work in isolation, there are always inconsistencies across organizations due to different business rules applied by different users. Another problem data analysis face is that the number of recommendations produced often is too high for the user to benefit from when there is no accounting for the goal of the user.

From the standpoint of users with IT/governance roles, the problem illustrated above also leads to undesirable data duplication issues. An example of the problem occurs when these professionals need access to relevant lookup tables. Foreign key definitions help identify the appropriate table to perform lookups, but these definitions often are missing in relational databases and non-existent in other types of data stores. Analysts typically have to reconstruct manually one set of data types (e.g., time zone information) from other data types (e.g., geographic information), leading to error and incorrect data results.

### SUMMARY

In the context of data transformation or preparation applications, where each application is a collaborative environment for data analysts, data scientists, and ETL developers to discover, explore, relate, acquire any type of data from data sources inside or outside the enterprise, the above problems are solved by a system that provides relevant dataset suggestions to a user based on the context of a prior dataset selection and an inferred goal. Specific improvements the are achieved by the systems and methods herein include reducing the average time to find data by reducing the manual steps to find the data, increasing the visibility of useful data assets by bringing them to the user, who selects and chooses, increasing reuse of analyses (over time), reducing inconsistencies as data users are exposed to the business rules of others (over time), and reducing duplication from the standpoint of IT/governance roles.

For example, as the user finds and includes in his current project the dataset with a “country code” column (but without the “country name”), the method and system described herein automatically recommends the lookup table with “country name” information, which has already been used in combination with the current dataset. In other words, a supplementary dataset. Thus, the analysts can also include the lookup table which he will then leverage at preparation time will not need to do the manual work to reconstruct the “country name” information.

Another common example of the problem is the need of data professionals to find if the dataset currently included in the project has already been extended via joins or unions with other relevant datasets. In this case, disclosed system automatically recommends the datasets that resulted from these previous joins or unions, allow the user to preview them, and, if ultimately chosen, avoid the user to repeat these manual join or union operations. In other words, an alternate dataset.

A second domain for applying the invention are the applications for ETL developers. This class of users would also benefit from join recommendations as they develop new mappings: currently they need to select manually sources and targets when building an ETL mapping, see Informatica Developer Tool. The limitations of these applications are analogous to those described above.

In one embodiment, a computer executed method of recommending datasets for data analysis. A recommendation system receives a user selection of a first dataset, for example, resulting from a search for dataset based on keywords or attributes. The system determines a context for the selection. Given the user selected dataset and context, for each of a plurality of dataset relationship types, a set of recommended datasets are identified. These recommended datasets are generated by first, determining at least one second dataset related to the first dataset based on the relationship type, scoring each second dataset using a relevance ranking algorithm specific relationship type to score the relevance of the of the second dataset to first dataset, and then ranking the datasets to determine the highest ranked datasets. From the ranked datasets, there are selected a plurality of ranked datasets as the recommended datasets, which are then presented in a graphical user interface.

The types of relationships that may be used to identify the recommended datasets include: a lineage relationship based on ancestor or descendant relationships between datasets; a content relationship based on semantically similar datasets; a structure relationship based on structurally compatible datasets; a usage based relationships based on datasets previously used by relevant classes of users in association with the previously chosen datasets; a classification-based relationship based on datasets that share one or more classifications with one or more datasets previously chosen by the user; and; an organizational or social relationship based on social or organizational relationships between users of the datasets.

After the recommended datasets are presented, a user selection of one or more of the recommended datasets is received. For the selected dataset, relationship type to the first dataset is determined, and a plurality of datasets related to the first dataset by the relationship type are further identified and scored for relevance. These further datasets are presented in the graphical user interface according to their subtypes for the relationship type.

In addition, a user interface provides a dataset selection control for receiving a user selection of a first dataset, and a recommendation bar for presenting a set of recommended datasets based on the user selection of the first dataset and a determined context for the selection, where the recommended datasets are grouped within the recommendation bar by relationship type to the first dataset. The user interface also includes a “goal” confirmation control for receiving a selection of one or more of the recommended datasets.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the detailed description and the accompanying figures. A brief introduction of the figures is below.

FIG. 1 is a block diagram of a system architecture according to one embodiment.

FIG. 2 is a data model diagram for representing information in the system according to one embodiment.

FIG. 3 is a flowchart of a method of recommending datasets for data analysis, according to one embodiment.

FIG. 4A1 illustrates a user interface showing a recommender bar with first recommendations based on a lineage relationship according to one embodiment.

4A2 illustrates the user interface of FIG. 4A1 showing a recommender bar with a menu control for selecting a goal for directing recommendations according to one embodiment.

FIG. 4B illustrates an alternative user interface in which the recommender bar shows alternate source datasets and related result datasets as recommended datasets according to one embodiment.

FIG. 4C illustrates an alternative user interface in which the recommender bar shows recommended datasets without categorization by relationship type according to one embodiment.

FIG. 5 illustrates the user interface of FIG. 4A1 showing a recommender bar with second recommendations based on a k-derived lineage relationship according to one embodiment.

FIG. 6 illustrates the user interface of FIG. 5 showing a recommender bar with third recommendations for k-derived lineage relationship for unions only according to one embodiment.

FIG. 7 illustrates a user interface showing a recommender bar with recommendations for a content relationship according to one embodiment.

FIG. 8 illustrates the user interface of FIG. 7 showing a recommender bar with second recommendations based on a related data content relationship according to one embodiment.

FIG. 9 illustrates the user interface of FIG. 8 showing a recommender bar with third recommendations based on a same content relationship according to one embodiment.

FIG. 10 illustrates a user interface showing a recommender bar with recommendations for an organizational or social relationship according to one embodiment.

FIG. 11 illustrates the user interface of FIG. 10 showing a recommender bar with second recommendations based on an organizational chart tie relationship according to one embodiment.

FIG. 12 illustrates the user interface of FIG. 11 showing a recommender bar with third recommendations based on a departmental relationship according to one embodiment.

FIG. 13 illustrates a user interface showing a preview of a dataset according to one embodiment.

FIG. 14 illustrates a decision tree for a lineage relationship between datasets according to one embodiment.

FIG. 15 illustrates a graphical example of an exemplary lineage for a report according to one embodiment.

FIG. 16 illustrates a decision tree for a content relationship between datasets according to one embodiment.

FIG. 17 illustrates a decision tree for a structure relationship between datasets according to one embodiment.

FIG. 18 illustrates a decision tree for a usage relationship between datasets according to one embodiment.

FIG. 19 illustrates a decision tree for a classification based relationship between datasets according to one embodiment.

FIG. 20 illustrates a decision tree for an organizational based relationship between users according to one embodiment.

### DETAILED DESCRIPTION

The figures and the following description relate to particular embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. Alternative embodiments of the structures and methods illustrated herein may be employed without departing from the principles described herein.

### System Architecture

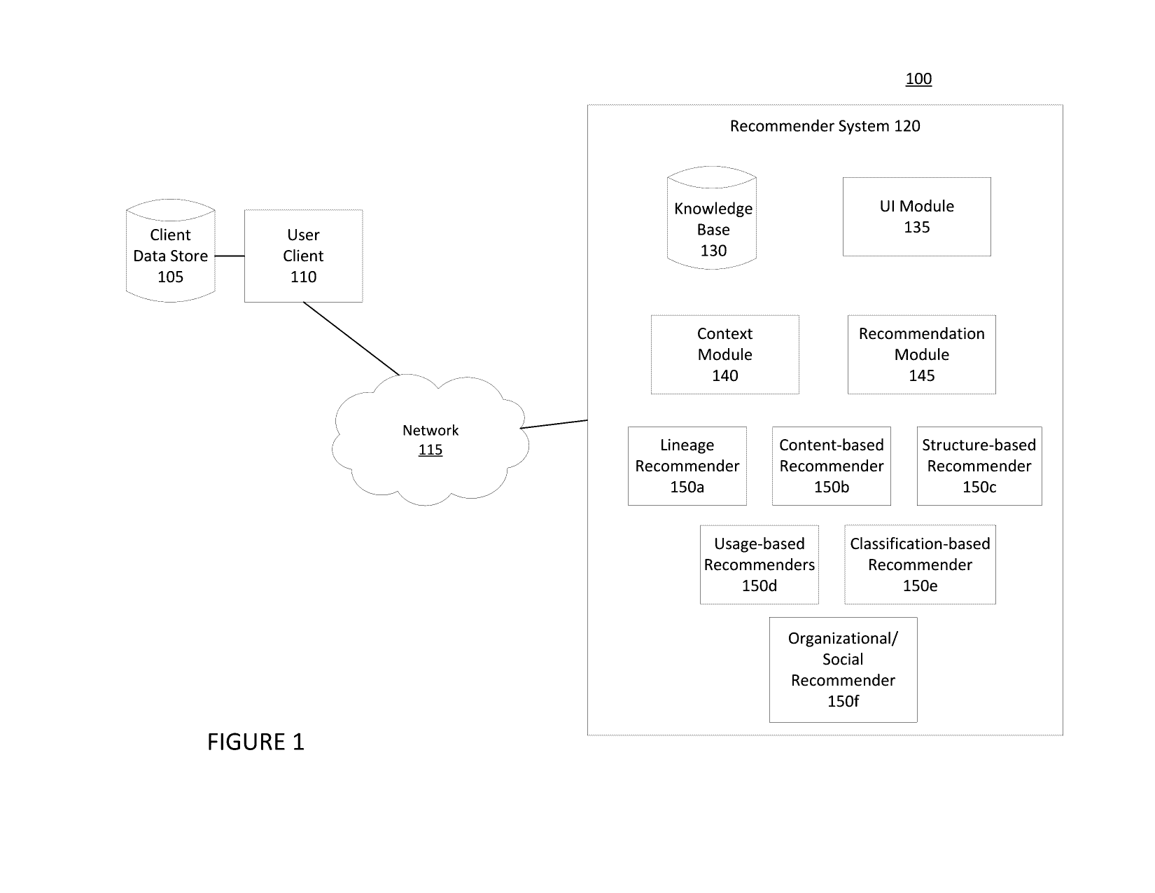

FIG. 1 is an architecture 100 for one embodiment of a recommender system.

The entities of the system 100 include user client 110, client data store 105, network 115, and recommender system 120.

Although single instances of user client 110, client data store 105, network 115, and recommender system 120 are illustrated, multiple instances may be present. For example, multiple user clients 110 may interact with recommender system 120. The functionalities of the entities may be distributed among multiple instances. For example, recommender system 120 may be provided by a cloud computing service according to one embodiment, with multiple servers at geographically dispersed locations implementing recommender system 120.

An user client 110 refers to a computing device that accesses recommender system 120 through the network 115. Some example user clients 110 include a desktop computer or a laptop computer. In some embodiments, user clients 110 include web browsers and third party applications integrating client data store 105. User client 110 may include a display device (e.g., a screen, a projector) and an input device (e.g., a touchscreen, a mouse, a keyboard, a touchpad). In some embodiments, user clients 110 have one or more local client data stores 105, which are databases or database management system that, e.g., provide access to source data via the network 115.

Network 115 enables communications between user client 110 and the data flow design system 100. In one embodiment, the network 115 uses standard communications technologies and/or protocols. The data exchanged over the network 115 can be represented using technologies and/or formats including the hypertext markup language (HTML), the extensible markup language (XML), etc. In addition, all or some data can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

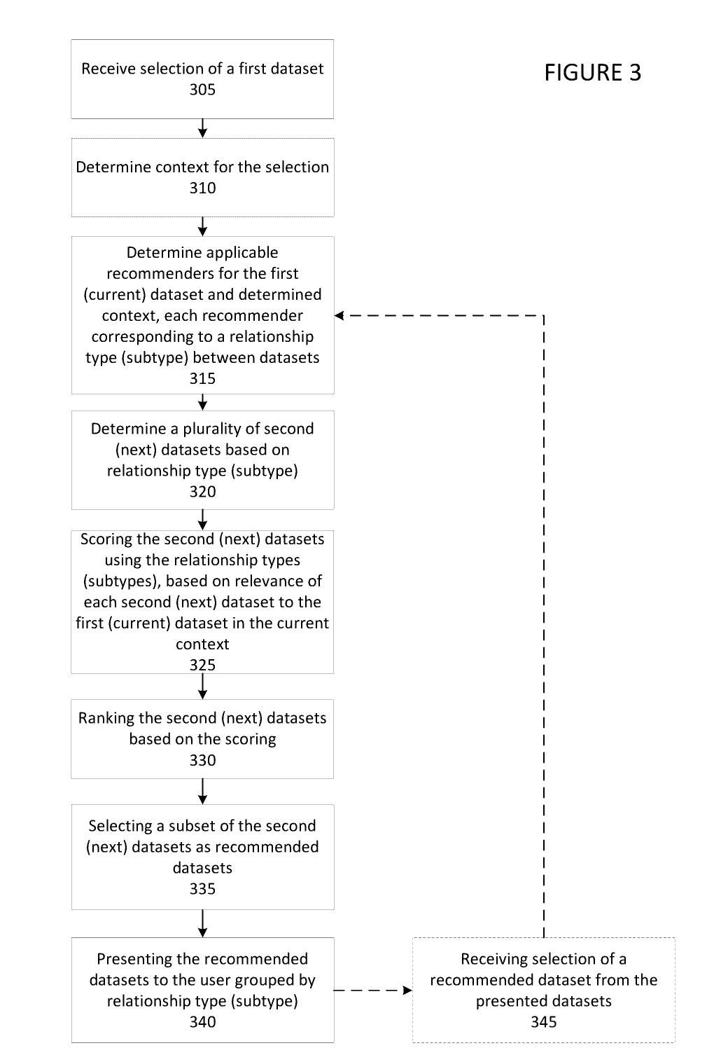

Recommender system 120 implements the method as described in conjunction with FIG. 3 according to one embodiment. Recommender system 120 includes a knowledge base 130, a user interface module 135, a context module 140, a recommendation module 145, and recommenders 150.

Recommender system 120 includes a user interface model 135 receives selection of a dataset from a user. Context module 140 determines the context for the dataset selection, using data from knowledge base 130. Based on the selected dataset and the context for the selection, recommendation module 145 determines the applicable recommenders and calls them.

Recommenders 150 then each determine datasets to recommend based on the corresponding relationship type for each recommender 150, using data from knowledge base 130. Recommendation module 145 then aggregates, scores, ranks, and selects a subset of the datasets provided by the recommenders 150 for presenting to the user, and user interface module 135 presents the selected datasets via a user interface. Each of the components 130-150 of recommender system 120 is discussed in further detail below.

Knowledge base 130 includes an inventory of datasets, profiles of users, data definitions that are used to define the semantics of datasets and data elements. Knowledge base 130 also includes data domain information, which data domains are used to define the types of data values. Knowledge base 130 includes classification schemes that can be used to classify the datasets and data elements. Knowledge base 130 also includes lists of projects that are used to group user actions performed on datasets to achieve some goal. Knowledge base 130 includes a map of relationships that encodes different types of relationships, including lineage relationships, content relationships, structure relationships, usage-based relationships, classification-based relationships, and organizational or social relationships between users. This map of relationships feeds into the various recommenders 150.

For each user, knowledge base 130 is loaded with existing intent knowledge, history of in-project actions, and individual preferences among the different relationship types derived from prior interaction history (e.g., user profiles). For example, classes used by context module 140 are stored by knowledge base 130, as shown in Table 1 below, which lists the classes of user actions, and the user goal inferred from each action.

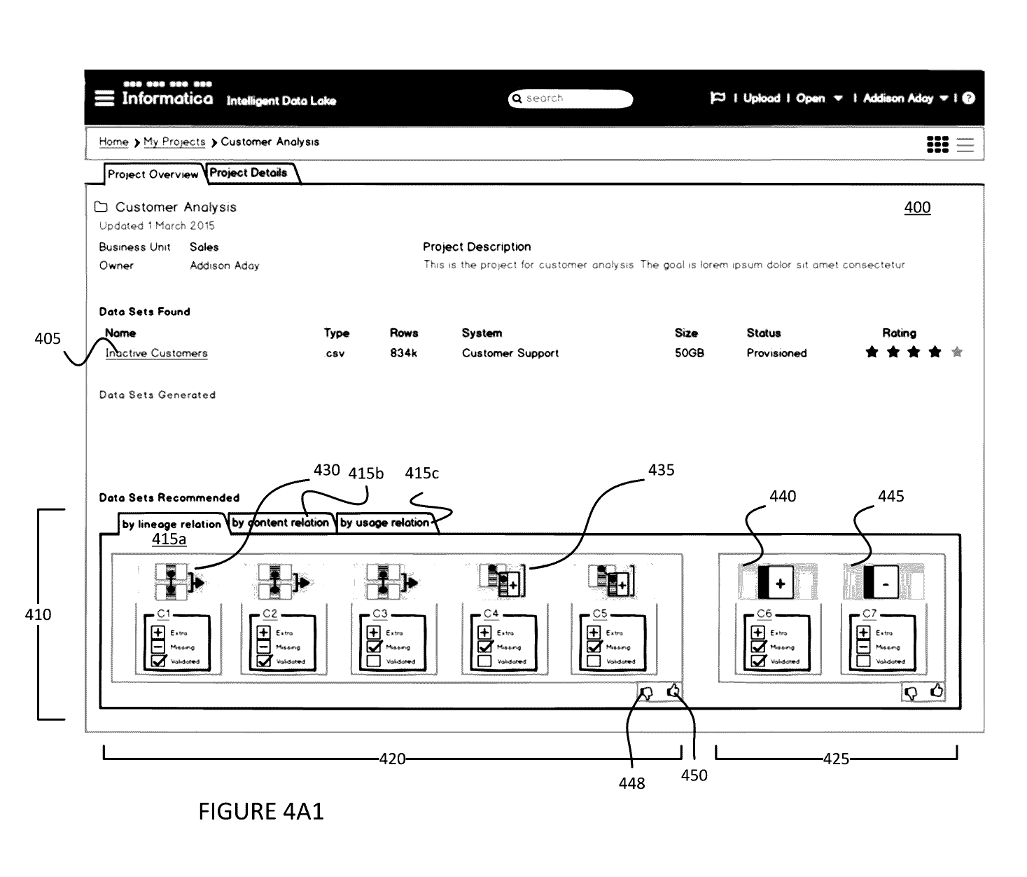

The three classes are as follows. Class 1 includes actions outside the context of a project, such as search history. Class 1 actions are used by the recommendation system 120 to initialize the recommendation process engine. Class 2 includes actions within the context of a project (excluding recommendations). Class 3 includes actions taken in the context of a list of recommendations provided to the user. Class 2 and 3 actions are used by recommender system 120 to revise the recommended datasets, e.g., using a stored decision tree as discussed below, which ultimately are displayed to the user, e.g., in recommender bar 410 of FIG. 4A1.

TABLE 1

| Class | User action | Ranking Relevance |
|---|---|---|
| 1 | User search history | Search history is used to influence the |
| | | ranking of the recommendations. E.g |
| | | “sales” appears a lot in search, rank |
| | | datasets related to sales higher |
| 1 | User becomes part of | Datasets published by other users in the |
| | a user group | same group are ranked higher |
| 1 | User starts “following” | Datasets published by peers followed are |
| | a peer | ranked higher |
| 1 | User starts “following” | Datasets similar to datasets followed are |
| | a dataset | ranked higher |
| 1 | User “rates” a data set | Datasets are manually rated by the users |
| | | as they inspect or add them to the project |
| 2 | User (re)names a | Tokens in the project name are used to |
| | project at project | search in the catalog and recommend |
| | creation time or later | datasets |
| 2 | User adds a dataset | Alternative source datasets or related |
| | to empty project | result datasets are recommended |
| 2 | User has multiple | Alternative source datasets or related |
| | datasets to project | result datasets are recommended, which |
| | | now is derived based on multiple |
| | | datasets |
| 2 | User deletes a | Alternative source datasets or related |
| | dataset from project | result datasets are recommended, which |
| | | now is derived based on new set of |
| | | datasets |
| 2 | User prepares a | Actions taken in preparation steps (“trim |
| | dataset in a project | names, extract quarter from the date, |
| | | validate city” etc.) are used to rank the |
| | | recommendations. Datasets that have |
| | | similar actions are ranked higher |
| 2 | User publishes a | Actions taken in preparation steps of a |
| | dataset in a project | published datasets are used to rank the |
| | | recommendations. Datasets that have |
| | | similar actions are ranked higher |
| 3 | User previews a | By clicking on the recommendation, the |
| | recommendation | user previews the dataset recommended, |
| | | to evaluate if it is worth adding to the |
| | | project |
| 3 | User accepts a | Related datasets are recommended based |
| | recommendation by | on one of the relationship types. |
| | adding a | |
| | recommended dataset | |

Knowledge base 130 includes data used by context module 140 for determining the context for the dataset selection, and data, such as the decisions trees discussed below, used by each recommender 150 to determine datasets to recommend to the user based on the corresponding relationship type for each recommender 150. The information maintained by knowledge base 130 for each of the relationship types is further described below.

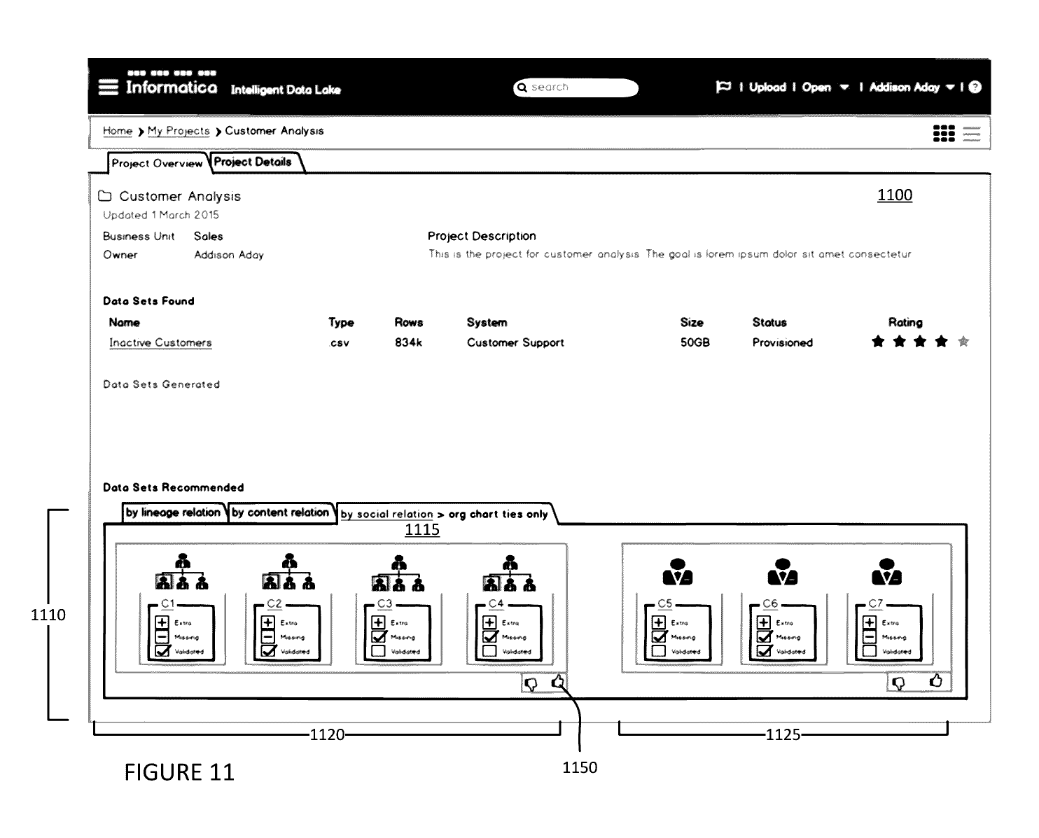

For the lineage relationships, knowledge base 130 maintains information about how the data has moved between different systems and transformed along the way. Knowledge base 130 also maintains a decision tree for lineage relationships, as shown in FIG. 14.

This decision tree of FIG. 14 shows datasets Cx recommended by lineage relationship, given a dataset A previously chosen by the user. In this decision tree, the intent information gained as the user selects recommendations based on the top-level decision. If the user is interested in 1-derivations of A (mono-parent), where C is a subset of A, by selecting a recommendation corresponding to the left side of the tree the user indicates interest in 1-derivations of A. This is illustrated by the common use case of sales operations analysts who for each analysis (aimed at creating a periodic report) need to derive a new datasets from a large, shared transactional dataset with all the sales transactions of the company. For example, one may be interested in subsets of sales transactions for a specific geographic region, another in the transactions for a specific family of products, etc. So, as the analyst exhibits the interest for 1-derivations (through selection of a recommendation) then the method and system recommends all the existing datasets Cx generated as subset of the same dataset A.

On the other hand, if the user is interested in k-derivations of A (plus other parents), where C is derived from A and at least one other dataset, by selecting a recommendation corresponding to the right side of the tree the user indicates interest in k-derivations of A. This is illustrated by the common use case of a marketing analyst who needs to join the “customer” dataset with the “orders” and “customer demographics” datasets in order to answer questions about who to target for a new marketing campaign (e.g., find the list of customers that have purchased product x and have demographics most relevant to the new product y). This type of use case requires combining information (e.g., attributes or dimensions) in complementary datasets. It happens frequently when the database schema is organized following dimensional modeling principles, i.e., the database schema stores one dimension per table where that dimension can be connected with the dimensions in other related tables, e.g., via joins or union operations. An example in which a user selects a lineage relation, then k-derivations, then union operations, is discussed further below in conjunction with user interface of FIGS. 4A1, 5, and 6.

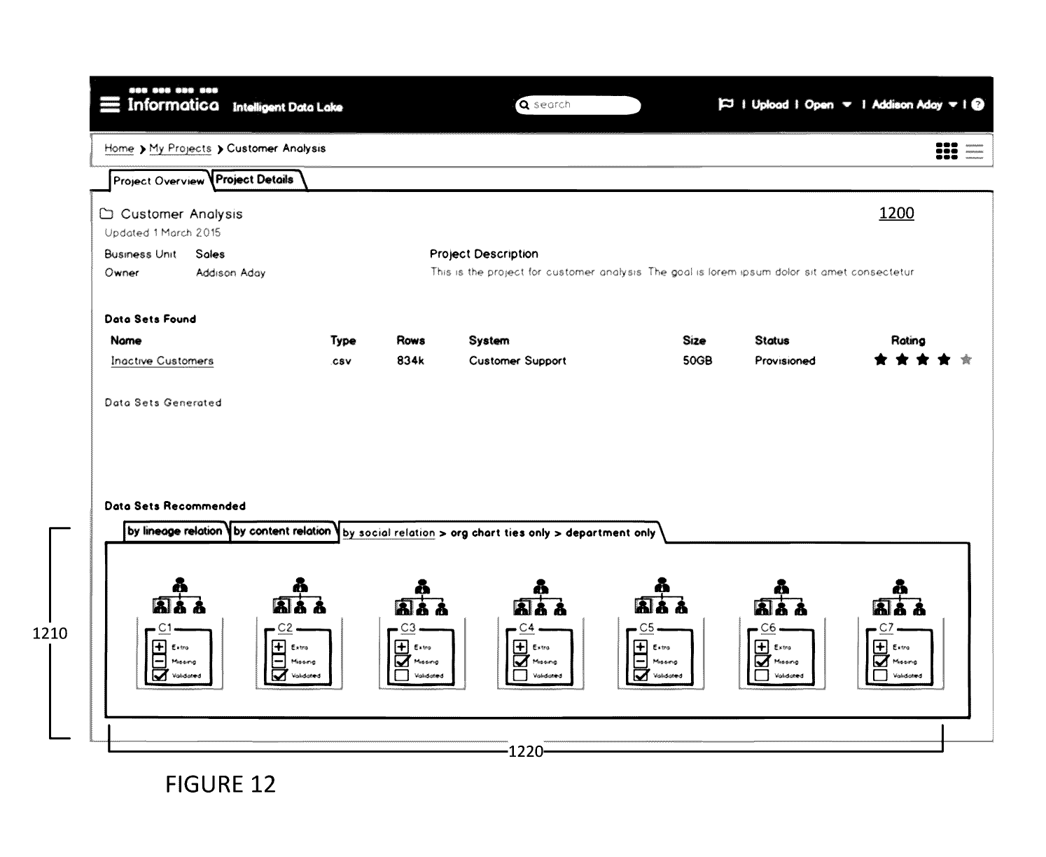

As an example, assume data is extracted from Table A in an ERP (Enterprise Resource Planning) system, transformed, and then loaded into a staging database table Table B. Then it is transformed again and loaded into a data warehouse table Table C. On that Table C, there a Business Intelligence Report that is built as Report 1. There is now a lineage relationship exists from Report 1 to Table C to Table B to Table A. Lineage relationship can be represented at table level as well column level. A diagram shown in FIG. 15 provides a graphical example of the lineage for a report called “cust_96” and published in the Salesforce (SFDC) Business Intelligence platform. A lineage diagram, shown in FIG. 15, displays the data in “cust_96” that is the result of multiple transformations of the data coming from the table “Customer Data.” The lineage relationship data in knowledge base 130 is used by lineage recommender 150a.

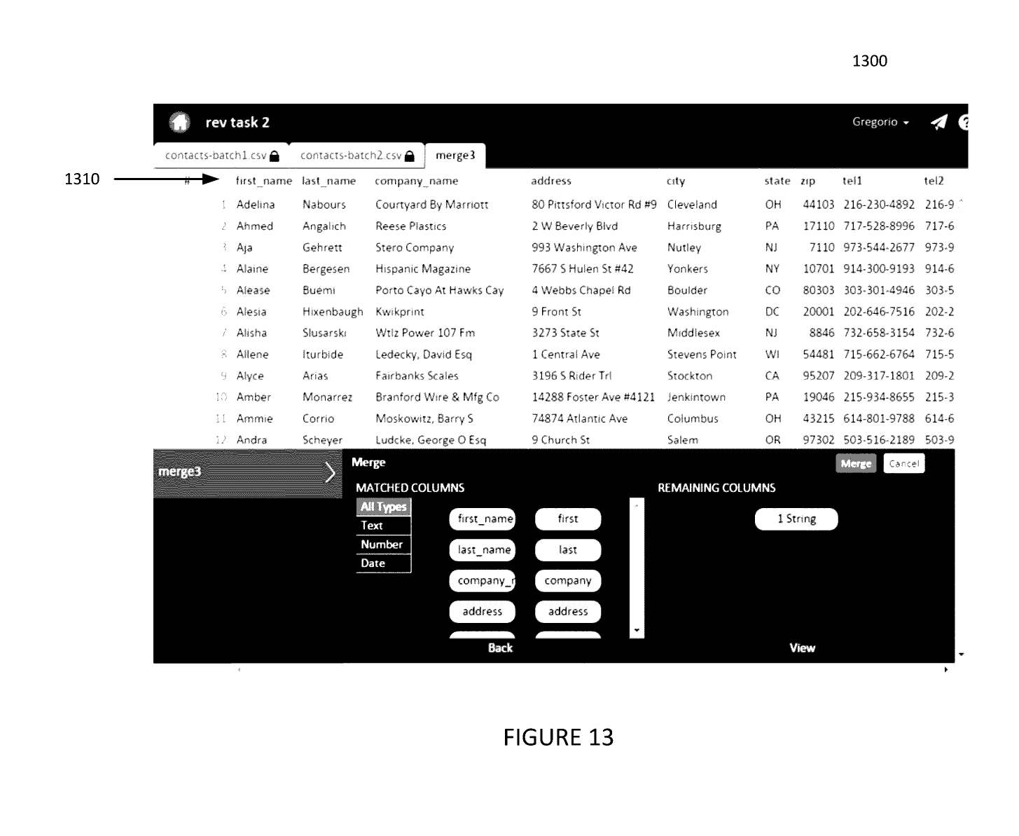

For the content relationships, knowledge base 130 maintains the relationships between datasets and data definitions that depict the semantics of the dataset, e.g., when datasets can be mapped onto a glossary of business terms. Knowledge base 130 also maintains a decision tree for content relationships, shown in FIG. 16.

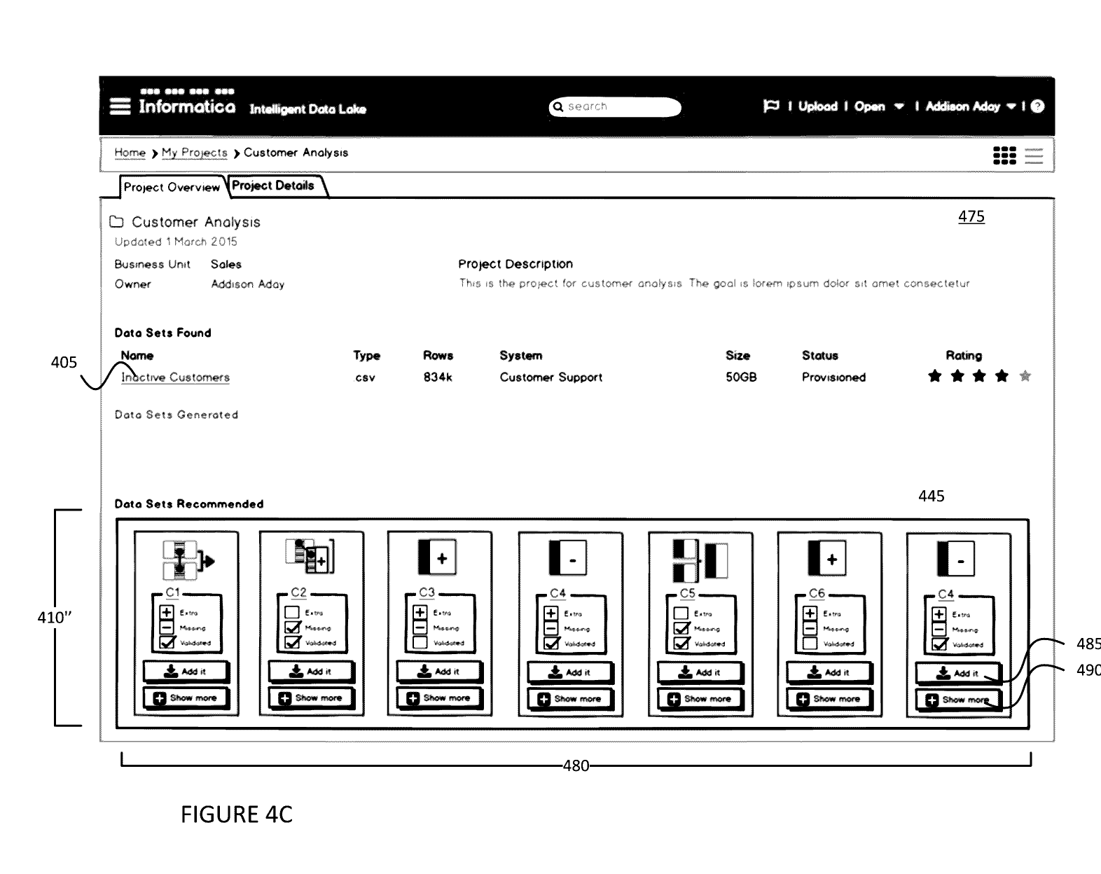

The decision tree of FIG. 16 shows datasets Cx recommended by content relationship, given a dataset A previously chosen by the user. In this decision tree, the intent information gained as the user selects recommendations based on the top-level decision. The user is interested in datasets with the same kind of content of A, where C contains the same domain and business entity as A (left side of tree). Alternatively, the user is interested in dataset with the same actual content of A, where C contains the same records as A, based on a fuzzy matching (right side of tree). An example in which a user selects a content relation, then related data content, then same content, is discussed further below in conjunction with user interface of FIGS. 7-9.

As an example, two particular datasets that represent the same business term “customer” are semantically similar at the data set level. Knowledge base 130 also maintains relationships between data elements and data definitions which represent the semantics of the data element, e.g., where two particular datasets both contain the same specific type of data, or a column with the same set (or overlapping sets) of values (i.e., all the value can be checked against a common reference table). For instance, they both contain a “social security number” column and thus they are semantically similar at the data element level. In another example, they both contain the same set of stores ISO country codes and thus they are semantically similar at the data element value level.

The content relationship data in knowledge base 130 is used by content-based recommender 150b.

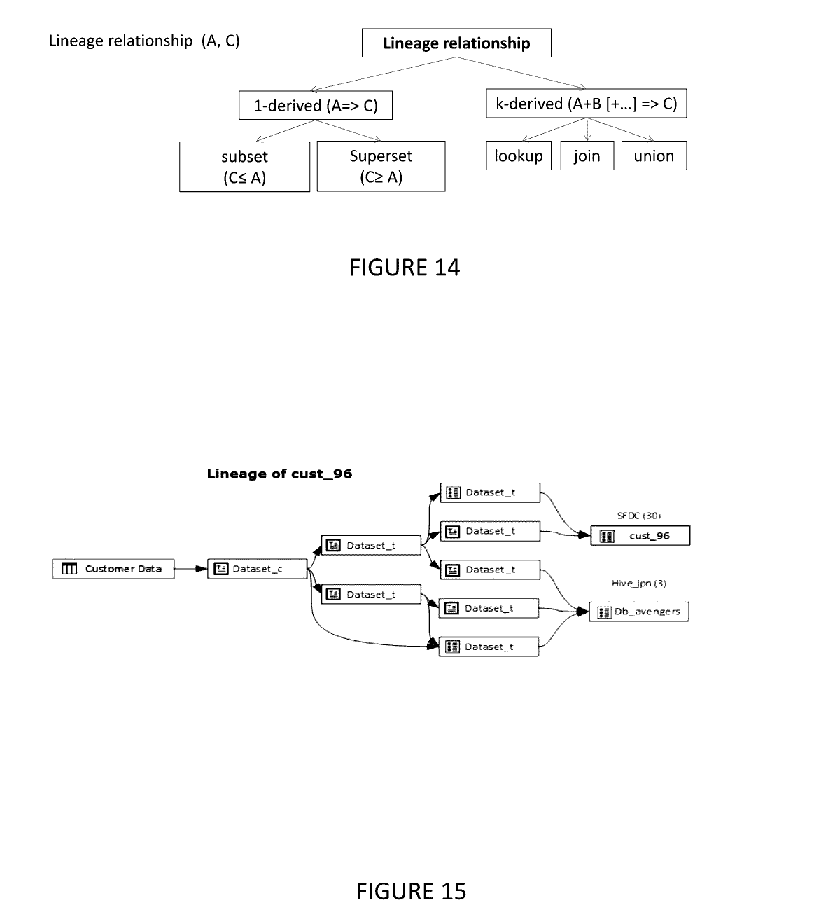

For the structure relationships, knowledge base 130 maintains the relationships between datasets and classifiers that classify datasets to be in the same group based on structural relationship such as PK-FK. Knowledge base 130 also maintains a decision tree for structural relationships, shown in FIG. 17.

The decision tree of FIG. 17 shows datasets Cx recommended by structure relationship, given a dataset A previously chosen by the user. In this decision tree, the intent information gained as the user selects recommendations based on the top-level decision. The user is interested in datasets in one example that are join-able with (or enriching) A, where C and A share a small number of key variables (left side of tree). Alternatively, the user is interested in datasets union-able with (or useful as reference tables for) A, where C and A share most key variables (right side of tree).

For example, a “customer” and an “order” dataset from the same organization and time period have in common the column “customer ID” as PK-FK, which allows performing structural operations such as Join and Lookup between the two dataset. Knowledge base 130 maintains the relationships between datasets and classifiers that classify datasets to be in the same group based on structural relationship such as highly overlapped dataset structures between the datasets (i.e., set-subset relationship between the attributes of two tables). In another example, two “order” datasets from two subsequent years have in common the same set of columns (or the one may have a superset of the columns in the other), which allows performing structural operations such as Union. The structure relationship data in knowledge base 130 is used by structure-based recommender 150c.

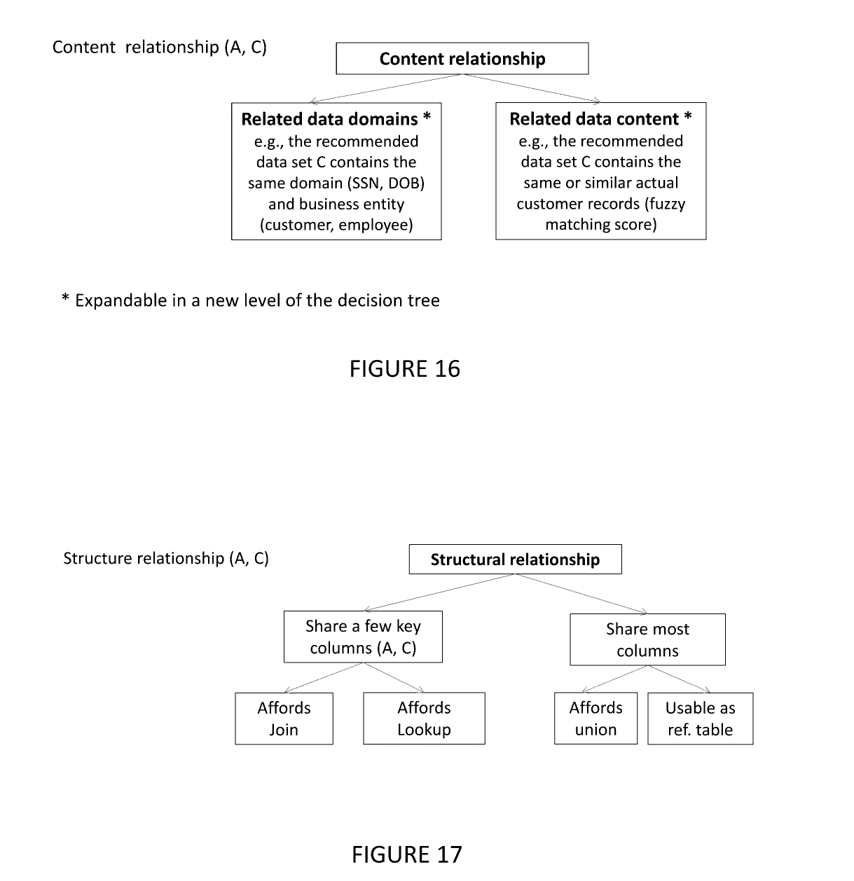

For the usage-based relationships, knowledge base 130 maintains the relationships between datasets and users about who created which dataset, who used which dataset, and who rated which dataset and what the rating was (rating, in this case, represents usefulness of this dataset for that particular user). Knowledge base 130 also maintains a decision tree for usage-based relationships, shown in FIG. 18.

The decision tree of FIG. 18 shows datasets Cx recommended by usage-based relationship, given a dataset A previously chosen by the user. In this decision tree, the intent information gained as the user selects recommendations based on the top-level decision. On one hand, the user is interested in datasets join-able with (or enriching) A, where the user of C is the same as the user of A (e.g., same author)(left side of tree). Alternatively, the user is interested in datasets union-able with (or ref for) A, where the user of A is related to the user of C in terms of role, department, location, data (right side of tree). The usage-based relationship data in knowledge base 130 is used by usage-based recommender 150d.

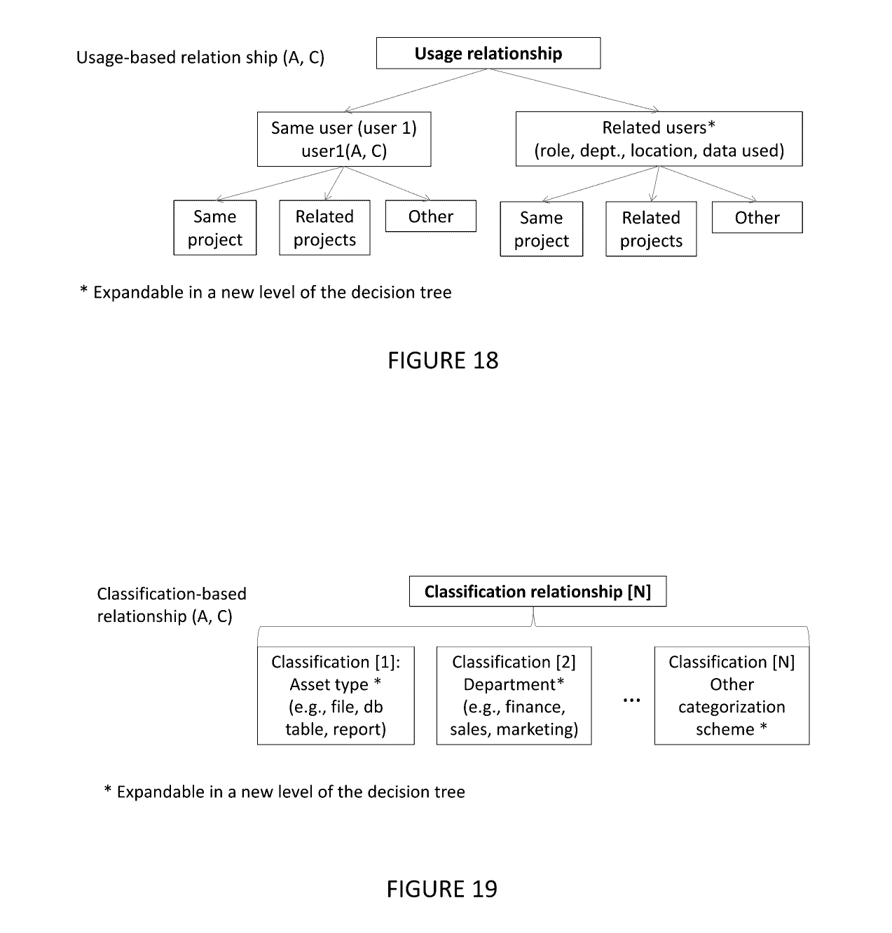

For the classification-based relationships, knowledge base 130 maintains the relationships between datasets and classifiers that classify datasets to be in the same group based on some classification scheme, e.g., a dataset may belong to a finance subject area, or a dataset may contain data for country USA. Knowledge base 130 also maintains the relationships between data elements and classifiers that classify data elements in the same group based on some classification scheme, e.g., a column containing sensitive information. Knowledge base 130 also maintains a decision tree for classification-based relationships, shown in FIG. 19.

The decision tree of FIG. 19 shows datasets Cx recommended by classification-based relationship, given a dataset A previously chosen by the user. The above tree shows an N (classifications relevant to A)×M (datasets related to A for sharing one or more classification). A decision tree is built based on the matrix. The decision tree branches represent the most common sub-sets of classification scheme: i.e., common among pairs of datasets related to A. The intent information gained as the user selects recommendations based on a tree derived from the matrix. For example, the user is interested in datasets classified similarly to A in the N categorization schemes available. The classification-based relationship data in knowledge base 130 is used by classification-based recommender 150e.

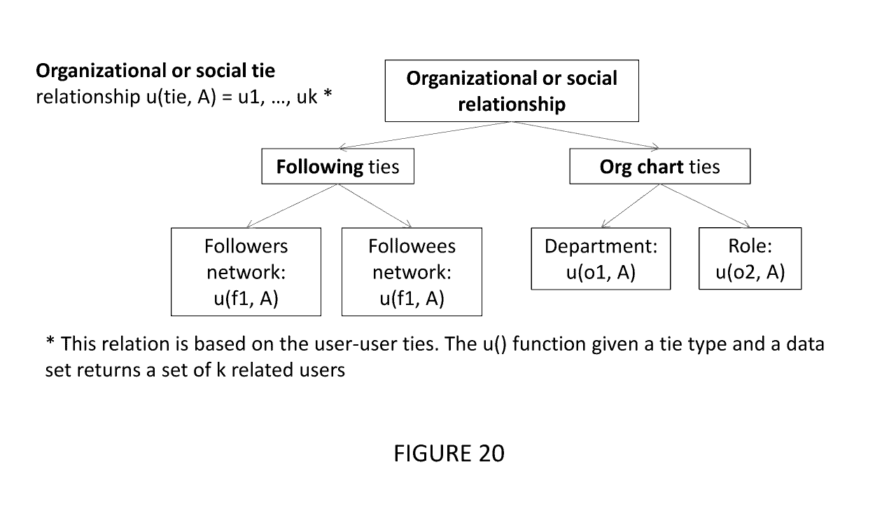

For the organizational or social relationships between users, knowledge base 130 maintains the relationships between users based on the user profiles, where information such as follower/followees and organizational chart attributes are specified. Knowledge base 130 also maintains a decision tree for organizational or social relationships, shown in FIG. 20.

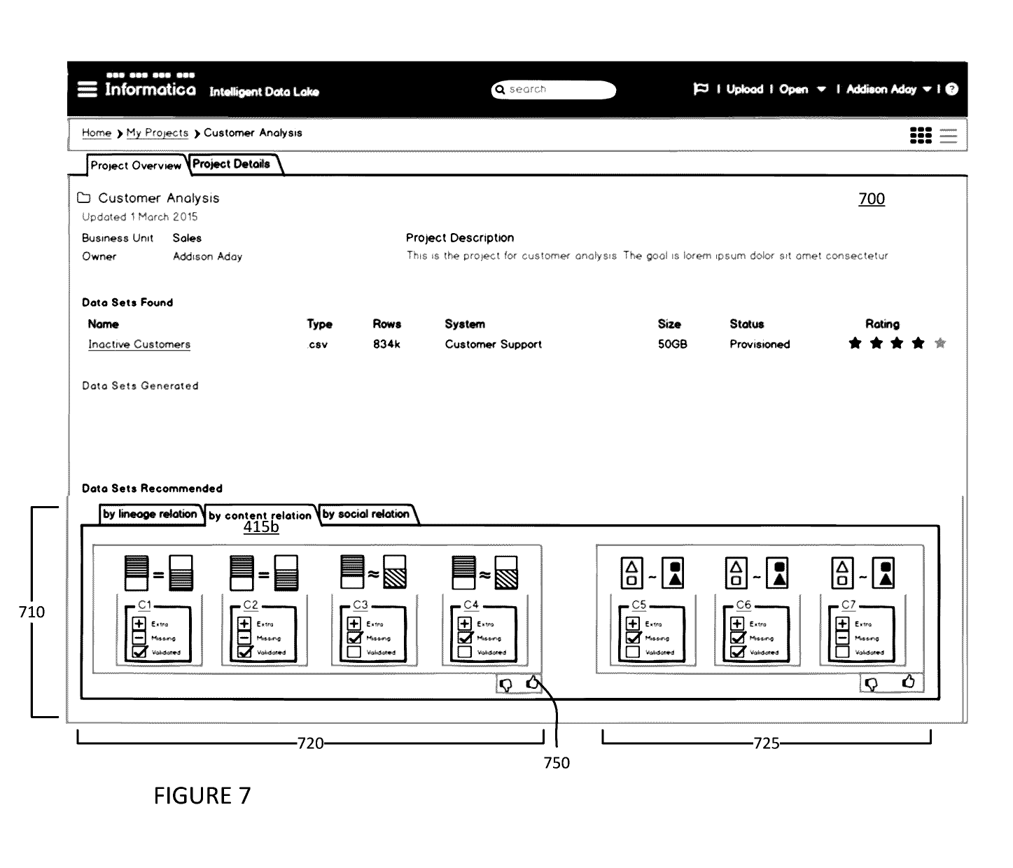

The decision tree of FIG. 20 shows datasets Cx recommended by organizational or social tie relevance, given a dataset A previously chosen by the user. In this decision tree, the relationship between datasets is based on the relationship of a user Ux and other users of the related datasets. For social tie relevance, a user is classified as either a follower or followee of another user, and the related dataset is one used by such other users. For organizational relevance, a user is in the same department or role as another user, and the related dataset is one used by others users in the same department or role. Accordingly, the intent information gains as the user selects recommended datasets. The user may be interested in datasets from followers or followees of the user of dataset A (left side of tree), or the user may be interested in datasets from users in the same department or role as the user of dataset A (right side of tree). An example in which a user selects a social relation, then organizational chart ties, then department ties, is discussed further below in conjunction with user interface of FIGS. 10-12. The organizational or social relationship data in knowledge base 130 is used by organizational/social recommender 150f.

Recommender system 120 also includes context module 140. Context module 140 infers goals, including goals based on user actions in the current session context. This context informs the dataset selection, using context data, such as Table 1, from knowledge base 130.

Context module 140 first determines context information for a selected dataset, which is then stored in knowledge base 130. Various contexts have corresponding classes assigned to them, which determine what goal is inferred from the user's selection of the dataset within that context. Three different classes correspond to actions taken in specific contexts, as shown in Table 1, which is stored in knowledge base 130. Using this information, the datasets next suggested to the user are based on the goal inferred from the context information.

Then, when a next action is taken by the user, context module 140 determines a (possibly different) context for the next action, which action either confirms the inferred goal or not. Context module 140 revises the inferred goal, if necessary, which then again informs the next datasets presented to the user, and so on. In this way, context module 140 iteratively determines the context in which specific actions, e.g., dataset selections, are made by the user to infer a user goal for the action, and the inferred goal in turn informs selection of the next datasets to suggest to the user.

Recommender system 120 also includes recommendation module 145. Given a user-selected dataset and context, recommendation module 145 provides recommended datasets for presenting to the user. Based on the selected dataset and the context for the selection, recommendation module 145 determines the applicable recommenders and calls them. Recommendation module 145 then aggregates, scores, ranks, and selects a subset of the datasets provided by the recommenders 150 for presenting to the user.

Recommendation module 145 determines which recommenders 150 should be called in view of a selected dataset and context, calls the recommenders 150, aggregates and scores the recommended datasets produced by each recommender 150, and selects the highest ranking datasets for presentation to the user by UI module 135, e.g., in recommender bar 410 in a graphical user interface such as is shown in FIG. 4A1.

For example, assume the system has n relationships in set R. The recommendation service has a matrix W of size n where W[i] is the weight of the recommendation produced by using the relationship R[i]. Each recommender produces local recommended datasets ranked by a relevance score based on some relationship in R, using a relevance ranking algorithm specific to the recommender and relationship type.

In one embodiment, the recommendation service starts with a default weights for each of the relationships and adjusts the weights according to the actions the user performs. The default weights can be equal across all recommenders, or configured per the user's profile. The scores of the recommended datasets from each of the recommendation lists are weighed by the current weight of the relationship in the recommendation service and aggregated and presented by decreasing rank.

As the user selects datasets for inclusion or previewing, the corresponding weight for the relationship type/recommender is incremented, and the remaining weights for the other relationship types/recommenders are adjusted.

Below is a pseudo-algorithm, with explanations, for the recommendation module 145.

| | |
|---|---|
| Class RecommendationService { | |
| Structure Recommendation { | |
| | Dataset |
| dataset | |
| | Number |
| score | |
| } | |
| Structure RecommenderProfile { | |
| | Recommender recommender |
| | Number |
| score | |
| | Number |
| weight | |
| } | |

Structure RecommendationContext {

| | |
|---|---|
| | UserContext |
| userContext | |
| | GoalContext |
| goalContext | |
| | ProjectContext |
| projectContext | |
| | Scope |
| | scope |
| } | |

Recommendation module 145 maintains a map of weights applied to various recommenders 150 within the context of various goals, e.g., at the project level, user level, or the session level:

### Map<GoalContext, Map<Recommender, Integer>>recommenderWeights

The set of recommenders 150 is registered with recommendation module 145 as:

### Set<Recommender>recommenders

The strategy decides how the weights applied to various recommenders 150 are adjusted

GoalInferenceStrategy goalInferenceStrategy

This method will be called by user client 110 to get recommendations:

```
      Map<Dataset, Map<Recommender, RecommenderProfile>>
getAggregateRecommendations(RecommendationContext
recommendationContext) {
      Map<Recommender, Integer> currentWeights
      Map<Dataset, Map<Recommender, RecommenderProfile>
aggregateRecommendations
```

Recommendation module 145 gets the recommender weights applicable in the current goal context:

if (recommenderWeights.contains(recommendationContext.goalContext))
currentWeights = ecommenderWeights.get(recommendationContext.-
goalContext)
else
currentWeights = getDefaultWeights( )
for (Recommender recommender in recommenders) {

Recommendation module 145 invokes the recommenders 150:

```
      if recommender.inScope (recommendationContext.scope)
      List<Recommendation> recommendations =
recommender.getRecommendations(recommendationContext)
      else
      continue
```

Recommendation module 145 aggregates the scores of all recommenders 150:

```
      for (Recommendation recommendation in recommendations) {
      Dataset dataset = recommendation.dataset
      if (aggregateRecommendations.contains(dataset))
      aggregateRecommendations.get(dataset).put(recommender, new
RecommenderProfile(recommender, score, weight))
      else
      aggregateRecommendations.put(dataset,
(new Map( )).put(recommender, new RecommenderProfile(recommender,
score, weight))
      }
        }
      return aggregateRecommendations
      }
```

This method is invoked by recommendation module 145 when a user accepts a recommendation. The recommendation module 145 uses that information to adjust the recommender 150 weights:

```
      acceptRecommendation (RecommendationContext
recommendationContext, Dataset dataset, Map<Recommender,
RecommenderProfile> recommenderProfiles) {
      Map<Recommender, Integer> currentWeights, adjustedWeights
      currentWeights =
recommenderWeights.get(recommendationContext.goalContext)
      adjustedWeights =
goalInferenceStrategy.adjustWeights(currentWeights,
recommenderProfiles)
      recommenderWeights.put(recommendationContext.goalContext,
adjustedWeights)
      }
}
```

Below represents an interface for adjusting weights:

interface GoalInferenceStrategy {
Map<Recommender, Integer> adjustWeights(Map<Recommender,
Integer> currentWeights, Map<Recommender, RecommenderProfile>
recommenderProfiles
}

Below shows one exemplary way of adjusting weights:

```
class StimulusOnlyStrategy implements GoalInferenceStrategy {
      Map<Recommender, Integer> adjustWeights(Map<Recommender,
Integer> currentWeights, Map<Recommender, RecommenderProfile>
recommenderProfiles {
          adjusted Weights = currentWeights.copy( )
          for(Recommender recommender in recommenderProfile) {
          currentWeight = currentWeights.get(recommender)
          score = recommenderProfiles.get(recommender).score
          adjustedWeight = currentWeight * ( 1 + score)
          adjustedWeights.put(recommender, adjustedWeight)
                                      }
return adjustedWeights
      }
}
```

In another embodiment, a hybrid recommender may be configured, using a combination of different relationship types (and their corresponding decision trees) and a combination of underlying relevance ranking algorithms for the different relationship types. In this embodiment, the recommendation module 145 invokes the applicable recommenders 150 based on a user action, prioritizes relationships based on inferred goals, and aggregates the response from the recommenders 150, and displays the results into the recommender bar, e.g. 410 of FIG. 4A1.

As mentioned above, recommender system 120 maintains a map encoding all the different types of relationships among all the datasets, e.g., in knowledge base 130. Based on this map, when the recommendation module 145 is given one or more datasets previously chosen by a user Ux, it can compute a set of recommendations to that user for each of the relationship types: lineage relationships allow recommendations of ancestor or descendants datasets, using the various recommenders 150 discussed below.

Recommenders 150a-150f each use a current context, e.g., as determined by context module 140, which has the following components: (1) datasets in the project (as the user-selected datasets A) and (2) the user (for the user's role, organizational department, and follower/followee relationships).

Each recommender 150a-150f includes program code that implements a relevance ranking algorithm that is specific to the relationship type of the recommender 150. Each relevance ranking algorithm computes a relevance score for another dataset within the relationship type, measuring the relevance of the other dataset to the given, user selected dataset.

Each recommender 150a-150f is normalized and trained. Recommender system 120 is loaded with relationships and decision trees, as discussed above in conjunction with knowledge base 130. For each user, the system generate a Finite State Automaton (i.e., a directed graph) that represents all the r possible states of a recommender bar: {s1, . . . , sr} based on the information. The states are based on the taxonomy of project types defined a priori by the system administrator before initializing the system (stored in Projects and Goals in knowledge base). Then, at initialization time, the taxonomy and the corresponding states for each project type is customized to each known user profile.

Recommender 150 are trained based on two list types: local lists and a global list. Local lists pertain to relevance scores, for each dataset A in the system, each of the individual recommenders 150 compute a distinct relevance score for each of the relationship types. A local list defines the relevance based on each relationship between the recommended Cj datasets and A, where 1<j<N. The global list is computed by the recommendation module 145 to produce a globally ranked list of related datasets {C1, . . . CM} as consolidation of the above-mentioned local lists provided by the recommenders 150.

When the applicable recommenders are called by recommendation module 145, each recommender 150 determines datasets to recommend based on the corresponding relationship type, using data from knowledge base 130.

The local lists are presented to the users upon demand based on the dataset included in the project and the state of the recommender bar. The recommendations may also have a temporal component, such that the recommender 150 provides periodic updates to the recommender lists (e.g., every year or quarter), or recommender system 120 uses the logs of user interactions taken on recommendations from a fixed period (e.g., full year) to train a predictive model for each of the r states and update the underlying taxonomy of project types. Then the Beta values in the trained model can be used as weights. The predictive model may or may not also factor in also the user role (e.g., data analyst, data scientist, chief data officer). The recommender 150 training discussed above then is repeated.

Each type of relationship corresponds to a particular decision tree logic and relevance ranking algorithm, for a specific recommender 150, as discussed below. Examples algorithms for each recommender 150 are also discussed.

Lineage-based recommender 150a recommends datasets that are descendants from one or more datasets in the current project. The lineage recommender 150a uses the systems knowledge of transformations of datasets and decisions trees, as stored in knowledge base 130, to come up with alternate dataset recommendations.

Assuming the system has knowledge of n data sets represented by the set D. Let's assume the system has knowledge of m transformation represented by the set T, with a context that has k datasets represented by the set C. The lineage recommender provides two types of recommendations, 1-derived and k-derived.

In the 1-derived example, recommender system 120 produces the set of j transformations 0 where j<m and each transformation O[j] in O contains exactly one source S where S belongs to C. Each O[j] in O is assigned a relevance score equal to the count of maps which map a data element of S divided by the count of data elements in S. A transformation that maps all the data elements of a source gets a score of 1, a transformation that does not map all the data elements in S get a score less than 1 and a transformation that maps the data elements of a source to more than one output in the target gets a score higher than 1. The system produces the list of recommendations which includes the targets of each of the transformations in TJ ranked by their relevance score.

In the k-derived example, recommender system 120 produces the set of j transformations O where j<m and each transformation O[j] in O contains at least one source S such that S belongs to C and each O[j] has more than one source. For each O[j] in O, let SI be the set of sources that belong to C and let SO be the set of sources that do not belong to C. Let A be the set of all sources. For each SI[i] in SI, compute a relevance score equal to the count of maps which map a data element of SI[i] to the target divided by the number of data elements in SI[i]. This is the positive participation factor. For each SO[o] in SO, compute a relevance score equal to the count of maps which map a data element of SO[o] to the target divided by the number of data elements in SO[o]. This is the negative participation factor. For each A[n] in A, compute a relevance score equal to the count of maps which map a data element of A[n] to the target divided by the number of data elements in the target. This is the contribution factor of each source. Compute the score of the transformation as the sum of positive participation factor times the contribution factor for each SI[i] in SI minus the sum of negative participation factor times the contribution factor for each SO[o] in SO. Return the set of targets of the transformations ordered by descending relevance score.

Content-based recommender 150b recommends datasets that are similar to the datasets in the project where the similarity between datasets is established by analyzing the data and metadata of the datasets. The content recommender 150b uses the similarity between datasets, computed using dataset names, column names, row counts, column values, data domains, business terms, and classifications, as a measure of the relevance between datasets. The content recommender 150b uses the decision tree for content relationships stored in knowledge base 130.

Consider S be a two-dimensional matrix where each S[m,n] is the similarity score (equivalently, relevance score) between data set D[m] and D[n]. A characteristic of this matrix is that it is a symmetrical matrix. A score of 0 means that the datasets are completely dissimilar while a score of 1 means that the datasets are identical. Most scores will be very close to zero with a few scores will be close to 1. The dataset similarities are computed in the background. The system uses similarity computed on the basis to dataset names, column names, domains and classifications to establish candidate lists for computing similarities based on values. The similarity between the datasets is computed using a variety of techniques including: n-gram cosine similarity for column names, TF-IDF cosine similarity, Bray-Curtis coefficient, or Jaccard co-efficient for column values using a comparison of data domains and comparison of classifications. Using any of the foregoing, a threshold of similarity is used for making recommendations. Let's assume the context has k datasets represented by the set C. For each C[k] in C, the system consults the similarity matrix and suggests datasets which have a similarity score greater than the similarity threshold in order of decreasing similarity score.

Structural recommender 150c recommender recommends datasets that have documented or inferred structural relationships (PK-FK, join, lookup, union) to datasets in the current project. The structural recommender 150C uses structural PK-FK or Join/Lookup relationships to make recommendations of related result datasets to use. The structural recommender 150C users the decision tree for structural relationships stored in knowledge base 130.

If recommender system 120 has knowledge of n data sets represented by the set D. Let's also assume that the system has knowledge of a matrix R where R[i,j]=1 when there is relationship between D[i] and D[j] with D[i] being the master dataset and D[j] being the detail dataset. Given that the system has knowledge of joins/lookups JL represented by matrix IL where JL[i,j] is equal to the frequency of join or lookup in the set of known transformations T between dataset D[i] and D[j] with D[i] being the master/lookup dataset and D[j] being the detail dataset.

Using R and JL, recommender 150c constructs a graph G where each node in the graph is a dataset and an edge in the graph is an element of R and/or IL with the weight of the edge being the frequency of use. Let's assume that the context has a set of k data sets represented by the set N. Then, for each dataset in N[k] in N, the recommender 150c finds immediate neighbors in G not already in N. For each pair of datasets in N (N[i], N[j]), the recommender finds the shortest path between the two datasets in the graph and add the nodes in the path to the result aggregating their weights to a net relevance score. The recommender produces the list of datasets ordered by decreasing relevance score.

Usage-based recommender 150d recommends datasets used together with one or more datasets in the current project by users proximate to the current system user. Usage-based recommender 150D uses the decision tree for usage-based relationships stored in content store 130.

There are two embodiments for a usage based recommender, usage-base 1 (source related usage) and usage-based 2 (target related usage). In usage-based 1, the usage recommender uses proximity between users to recommend datasets most used by users proximal to the context user to identify alternative source datasets.

If the system has knowledge of N data sets represented by the set D, consider that system has the identities of M users represented by the set U. Consider P to be a three-dimensional matrix where each P[i,j,k] is the proximity between user U[i] and U[j] by dimension Dk where k=0 is department, k=1 is role, k=2 is as follows: P[ij,0]=1 if users Ui and Uj are in the same department else it will be 0. By definition, P[i,j,0]=P[j,i,0]; or P[i,j,2]=1 if user Ui follows user Uj. P[i,j,2] need not be equal to P[j,i,2]. Other dimensions of proximity may be computed based on shared interests, shared project participation, etc.

Let G be a three-dimensional matrix where G[i,j,k] is the frequency of use of dataset D[i] to produce dataset D[j] by user U[j], where D[i] is a candidate alternate source dataset (e.g., as shown in FIG. 3B). This matrix is produced by processing the transformation knowledge. Let's assume the context has user U and k datasets represented by the set N. Then, for every dimension, the recommender accesses the proximity matrix P and identifies the users proximal to the context user. For each proximal user, the recommender accesses the usage matrix G and collects the datasets produced by the proximal user from any of the datasets present in the set N. The recommender produces a ranked list of recommendation by total frequency of use by each proximity dimension, where frequency of use serves as the relevance score, and the list is ranked from most frequent use (highest relevance) to least frequent use.

The usage based-2 recommender uses proximity between users to recommend datasets most used by users proximal to the context user to identify alternative target datasets. If the system has knowledge of n data sets represented by the set D, consider that system has knowledge of m users represented by the set U. Consider P to be a three-dimensional matrix where each P[i,j,k] is the proximity between user U[i] and U[j] by dimension Dk where k=0 is department, k=1 is role, k=2 is as follows: P[ij,0]=1 if users Ui and Uj are in the same department else it will be 0. By definition, P[i,j,0]=P[j,i,0]; or P[i,j,2]=1 if user Ui follows user Uj. P[i,j,2] need not be equal to P[j,i,2]. Other dimensions of proximity may be computed based on shared interests, shared project participation, etc.

Let G be a three-dimensional matrix where G[i,j,k] is the frequency of use of dataset D[i] with dataset D[j] to produce some other result by user U[k], where D[j] is a candidate alternate target dataset (i.e. a related result dataset; see FIG. 21 below). This matrix is produced by processing the transformation knowledge. Let's assume the context has user U and k datasets represented by the set N. The recommender accesses the proximity matrix P for every dimension of proximity and identifies the users proximal to the context user by each proximity dimension. For each proximal user along each dimension, the recommender accesses the usage matrix G and collects the datasets produced by the proximal user from any of the datasets present in the set N. The unique list of datasets is produced by collecting the datasets and it is ranked by the total frequency of use, where frequency of use serves as the relevance score, and the list is ranked from most frequent use (highest relevance) to least frequent use.

Classification-based recommender 150e recommends datasets that have been similarly classified (manually or using ML techniques) to one or more datasets in the project e.g. finance business function. Classification based recommender 150E uses common classifiers to recommend related result datasets. The classification based recommender 150E uses the decision tree for classification-based relationships stored in knowledge base 130.

If the system has knowledge of n data sets represented by the set D, assume the system m classifiers represented by the set C. Consider DC to be a two-dimensional matrix where DC[i,j]=1 if dataset D[i] is classified by classifier C[j] and DC[i,j]=0 if it is not. For each data element in dataset D[i] that is classified by classifier C[j] add 1 to DC[i,j] to compute a relevance score.

Given that the context has k datasets represented by the set N. For each dataset, from matrix DC the recommender 150a collects all datasets that have been classified by the same classifier aggregating their relevance scores by each classification scheme. The recommender 150c returns the list of datasets ranked by relevance score per classification scheme.

Organizational and social recommender 150f recommends datasets that have been similarly classified based on the organizational or social ties between the author or editor of the datasets already included in the project and other authors associated to them via such ties (follower-followed tie, same-department tie, etc.). Social networking techniques are used as part of this recommender. Organizational and social recommender 150F uses the decision tree for organizational or social relationships stored in knowledge base 130.

For the organizational or social relationships between users, the recommender 150g maintains the relationships between users based on the user profiles where information such as follower/followees and org chart attributes are specified.

Recommender system 120 further includes user interface module 135. User interface model 135 receives selection of datasets from a user; and presents the selected datasets via a user interface. User interface model 135 also provides user client 110 with access to the system, and can optionally show the inferred user goal (e.g., as shown in FIG. 4A2), and allows the user to accept or replace it with a different data analysis goal, such as “find a cleaner dataset,” “enrich the dataset,” or “integrate datasets.”

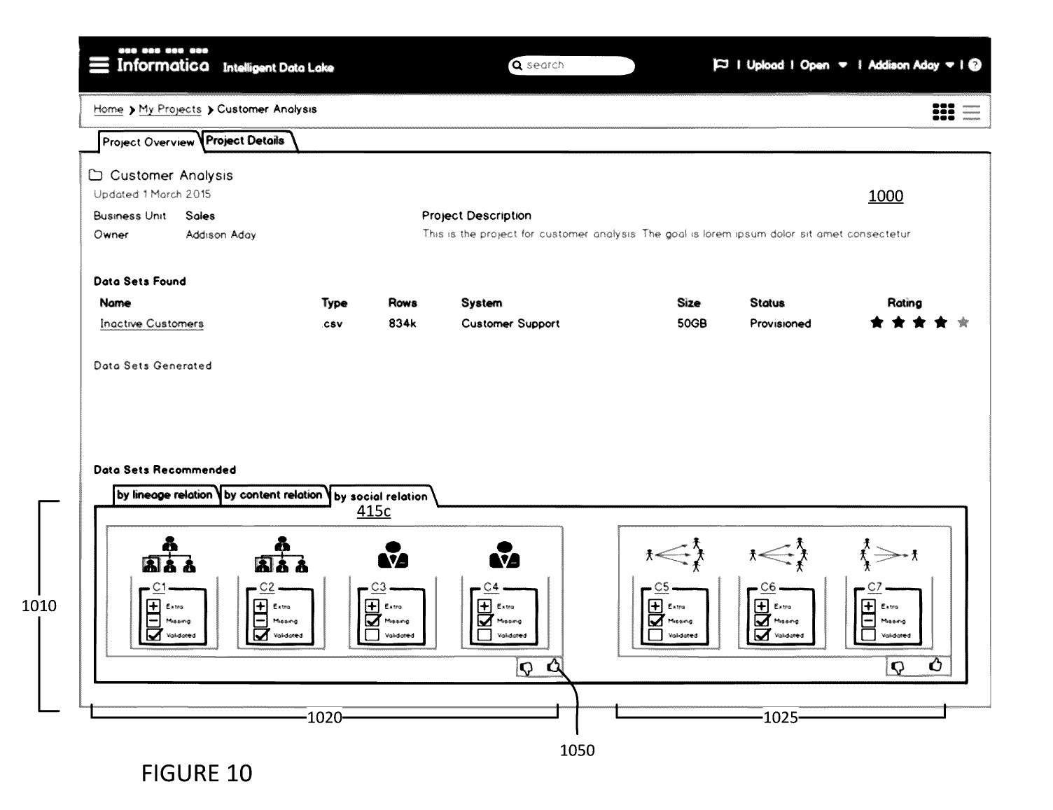

User interface module 135 enables two dedicated visualizations components. First, a recommender viewer that shows each of the datasets in the ranked list (recommendations) ‘in relation to’ the dataset A selected by the user. The user interface visually shows if the type of content relation (superset/subset of the rows/columns in A) and the diff statistics in terms of profiling information between A and the proposed C (type of added columns, change in metadata such as number of rows, columns, or quality metrics), e.g., as shown in C1-C6 of FIG. 4A1. Second, a preview function can be called as the user selects of one of the datasets in the recommender bar, to be displayed as a preview, e.g., as discussed in conjunction with FIG. 13.

User interface module 135 implements all of the user interfaces shown in FIGS. 4A1-13.

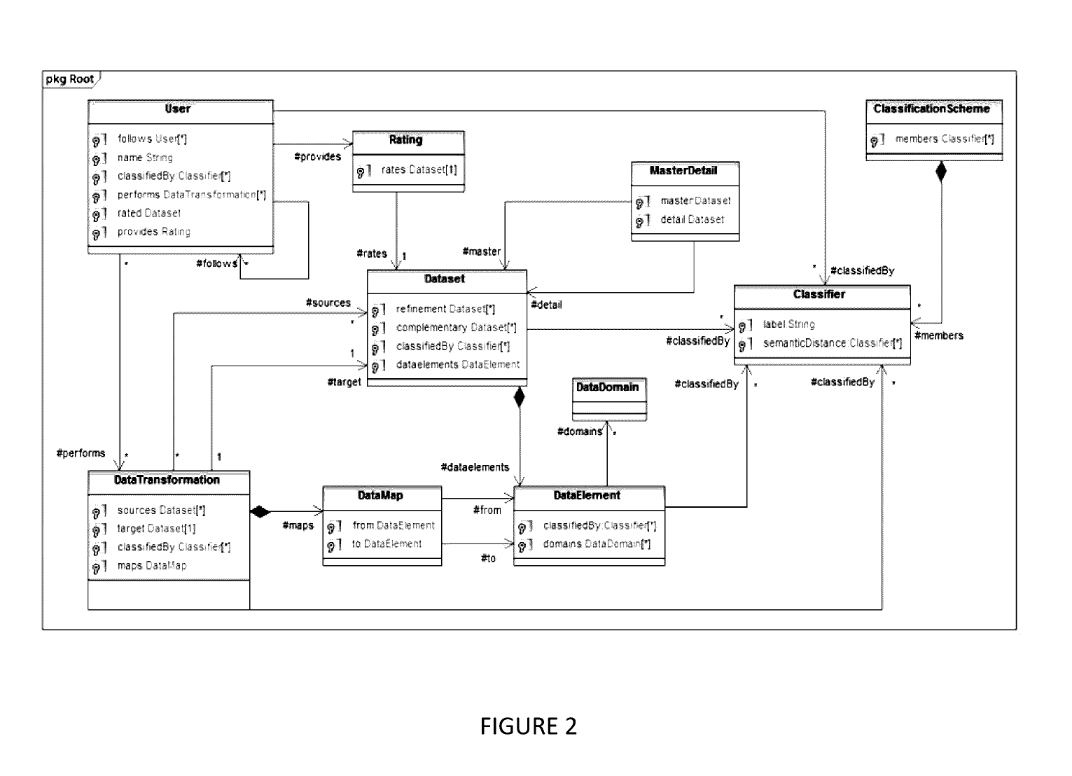

FIG. 2 shows a data model as implemented by recommender system 120 in one embodiment, according to the following classes shown. A Dataset is a class that abstracts a file, table, view, etc. of interest to a user. A DataElement is a class that abstracts a column of a dataset of interest to a user. A Relationship is a class that abstracts an association between datasets that have a structural relationship like PK-FK, Join, Lookup. A Transformation is a class that abstracts a data transformation task performed by a user that produces a dataset using other datasets as input. A Map is a class that abstracts a mapping between the data elements of the sources and the target of a transformation. ClassificationSchemes are classes that represent a scheme to classify other objects (users, datasets, transformations) e.g. role for classifying users, business function for classifying tables, etc. A Classifier is a class that represents a member of a classification scheme used as a classifier e.g. architect could be a classifier in the role scheme for classifying users. A DataDomain represents a semantic data type that can be discovered by applying rules e.g. SSN, email, etc. A User is a class that represents users of the system. A Rating is a class that represents the explicit user assessment of a dataset.

### System Flow

Referring to FIG. 3 there is shown a flowchart of a method of recommending datasets for data analysis, according to one embodiment.

The method begins with receiving 305 a user selection of a first dataset. When a user takes action in a project, recommender system 120 infers user intent based on three classes of actions taken by a user, as discussed above in conjunction with Table 1.

Referring also to FIGS. 4A1-4C, there are shown examples of a user interface provided to a client device by recommender system, according to various embodiments. FIG. 4A1 illustrates a user interface 400 showing a recommender bar 410 with first recommendations based on a lineage relationship according to one embodiment. In the example shown in FIG. 4A1, the user has selected 305 the dataset “Inactive Customers” 405 to the user's project (“Customer Analysis”), as illustrated. The user selection 305 of the (first) dataset may occur when recommender system 120 receives user query, e.g., for the key words “inactive customer data.” Recommender system 120 processes these key words and searches them against the various datasets (e.g., the database tables and associated metadata stored in knowledge base 130) for matching datasets. The results of the search include the dataset “Inactive Customers,” the selection 305 of which results in the user interface 400 shown in FIG. 4A1.

After the receiving the dataset 405 (“Inactive Customers”), recommender system 120 processes this action according to the user actions in Table 1, in which the user action of adding a dataset to an empty project results in a recommendation of alternative source datasets or related result datasets. In so doing, the method determines 310 a context corresponding to the user selection of the first dataset, or if a prior context existed, is determines the updated context.

Based on the first dataset and determined context, the next step in the method is determining 315, one or more dataset recommenders, each of the one or more recommenders corresponding to a relationship type between datasets. Recommender system 120 transfers the user context to each recommender 250, or if a prior context existed, is transfers the updated context.

Based on the relationship types, the method then determining 320 a plurality of second datasets related to the first dataset. Each recommender 250 consults the context and knowledge base 130 and computes its list of recommended datasets.

Each of the plurality of second datasets are then scored 325 using a relevance ranking algorithm specific to the corresponding relationship type to score the relevance of the of the second dataset to first dataset, and ranked 330 based on the scoring.

The method then selects 335 a subset of the ranked datasets as the recommended datasets. In one embodiment, recommender system 120 aggregates the recommendation lists from the different recommenders 250 and selects the highest ranking datasets from the different recommenders 250. User interface module 135 presents 340 the recommended datasets in a graphical user interface, e.g., 400 of FIG. 4A1, wherein the recommended datasets are grouped by relationship type to the first dataset. The recommended datasets 415, 420 are presented to the user in the recommendation bar, e.g., 410 of FIG. 4A1.

In this example, specific data sets Cx are recommended for a given dataset A based on each type of relationship. Thus, the user interface 400 displays the first set of several recommendations 420, 425 in the recommender bar 410, categorized in two groups by lineage relationship (shown by tab 415a): k-derived datasets 420 (datasets C1-C3: join) and (C4-C5: lookup); and 1-derived datasets 425 (C6: columns added; C7: columns removed). Datasets C1-C3 are represented by a join icon 430 indicating a join operation, indicating that each of these dataset resulted from a join operation of the Inactive Customer dataset with another dataset. Datasets C4 and C4 are represented by a lookup icon 435 indicating a lookup operation, indicating that each of these datasets resulted from a lookup operation the Inactive Customer dataset. Dataset C6 is represented by a column add icon 440 indicating a column add operation, indicating that this dataset resulted from the addition of one or more columns to the Inactive Customer dataset. Dataset C7 is represented by a column remove icon 445 indicating a column remove operation, indicating that this dataset resulted from the removal of one or more columns from the Inactive Customer dataset. Each dataset Cx also shows information indicating whether the data was validated, included extra data, or had missing data (“Extra,” “Missing,” and “Validated” labels). Other tabs 415 are available for recommendations based on content relationships and usage relationships.

FIG. 4A2 illustrates a user interface 400′ similar to FIG. 4A1, but showing a recommender bar 410 with a menu control 455 for selecting a goal for directing recommendations according to one embodiment. In this example, the user can select from drop down menu 455 to select a goal to help refine the dataset selections provided.

FIG. 4B illustrates an alternative user interface 460, in which the recommender bar 410′ shows alternate source datasets 465 and related result datasets 470 as recommended datasets according to one embodiment. The alternate source datasets 465 are recommendations for datasets to use instead of one or more dataset(s) in the current project. For example, somewhere in the data there is a better starting point for this project. The related result datasets 470 are recommendations for datasets to use instead of the dataset expected as a result of the current project. For example, somewhere in the data there is already the analysis result that the analyst is trying to create in this project. The recommendations are classified as alternate source datasets 465 when they come from the following three recommenders 250: the lineage-based recommender 150a, one of the usage-based recommenders 150d (usage-based-1), and the classification-based recommender 150e. The recommendations are classified as related result datasets 470 when they come from the following recommenders: the structural recommender 150c, one of the usage-based recommenders 150d (usage-based-2), the classification-based recommender 150e, and the organizational and social recommender 150f.

FIG. 4C illustrates a second alternative user interface 475, in which the recommender bar 410″ shows recommended datasets 480 without categorization by relationship type, according to one embodiment. In this embodiment, the recommendations 480 from the most relevant relationships are displayed in one list independently of the relationship categories, where the user can preview (by clicking on or hovering on the thumbnail), add it to the project via control 485, or, ask the recommender system 120 to show more like the dataset at hand by selecting the show more control 490.

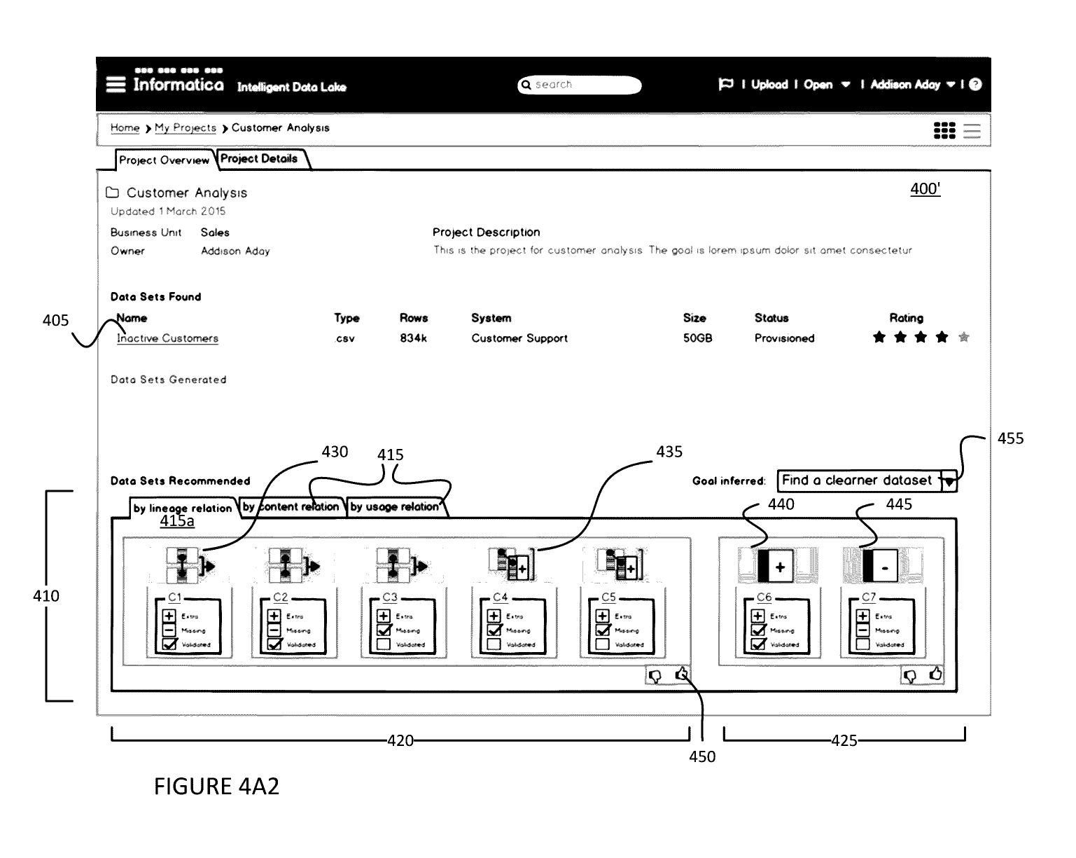

Returning to FIG. 3, in response to receiving 345 a selection of one or more recommended datasets (420, 425, 465, 470, 480), the method provides a second level of recommended datasets, which the causes recommender system 120 to repeat steps 315-340, with the selected dataset(s), selected form the recommended datasets replacing the first dataset in the method. This action is processed by recommender system 120 according to the user actions in Table 1, specifically Class 1 (user rating a dataset), using the decision tree for the k-derived relationship discussed above for recommender 150a, since the datasets here C1-C5 were k-derived (i.e., having more than 1 parent dataset, e.g., database Inactive Customers and at least one other dataset). In this example, group 420 of FIG. 4A1 is selected via icon 450, resulting in the user interface 500 of FIG. 5, which narrows the recommender bar 510 datasets to those with a lineage relation and further that are k-derived. FIG. 5 is discussed in further detail below. Alternatively, the user could reject/correct (thumbs down icon 448) the group 420 of FIG. 4A1, which would then be used to guide the next iteration of recommendations. If the user ignores the recommendation set, the method would return to the first step 305.

### Recommender User Interface and Example

Returning to FIG. 4A1, recommended datasets 420, 425 are presented, according to step 340 of the above method, in a recommendation bar 410 of a graphical user interface 400 as described above, grouped by relationship type of the recommended datasets 420, 425 to the first dataset 405. When the user selects (step 345), e.g., group 420 of FIG. 4A1 via icon 450, this action is processed by recommender system 120 according to the user actions in Table 1, specifically Class 1, the user rating a dataset, using the decision tree for the k-derived relationship stored in the knowledge base 130, since the datasets here C1-C5 were k-derived (having more than 1 parent dataset, i.e., database inactive Customers and at least one other dataset). Recommender system 120 then generates a further set of recommendations within the k-derived relationship type, but now categorized by types of k-derived relation. The result is presented (340) in user interface 500 of FIG. 5, which narrows the recommender bar 510 to three groupings of datasets 520 (C1-C3: join), 523 (C4-C5: lookup), 525 (C6-C7: union) with a lineage relation and further that are k-derived, as indicated in updated tab 515.

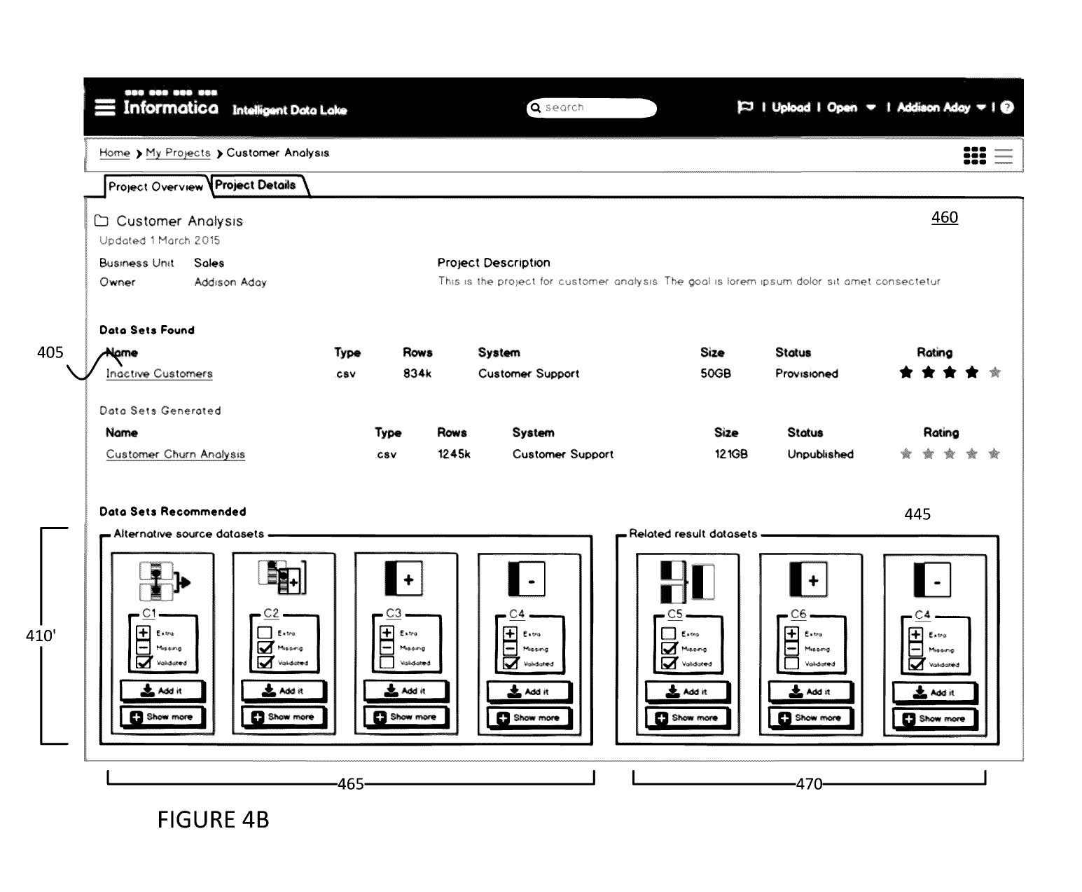

Continuing with FIG. 5, the user interface 500 receives a user selection (340) of the “k-derived” lineage relation of “union” by clicking on the thumb-up icon 550 for the right most group 525. This action is processed by recommender system 120 according to the user action again using the decision tree for the k-derived relationship, since the datasets here 525 (C6-C7) were k-derived (having more than 1 parent dataset, i.e., database Inactive Customers and at least one other dataset). Recommender system 120 generates a further set of recommended datasets 620 that are all of the union type of operation, resulting in the recommender bar 610 of user interface 600 of FIG. 6.

In another example, recommender system 120 receives a user selection of the content relation tab 415b. The result is shown in the user interface 700 of FIG. 7, which displays a second set of recommendations 720 (C1-C4), 725 (C5-C7) in the recommender bar 710, categorized in two groups by content relationship (shown by tab 415b).

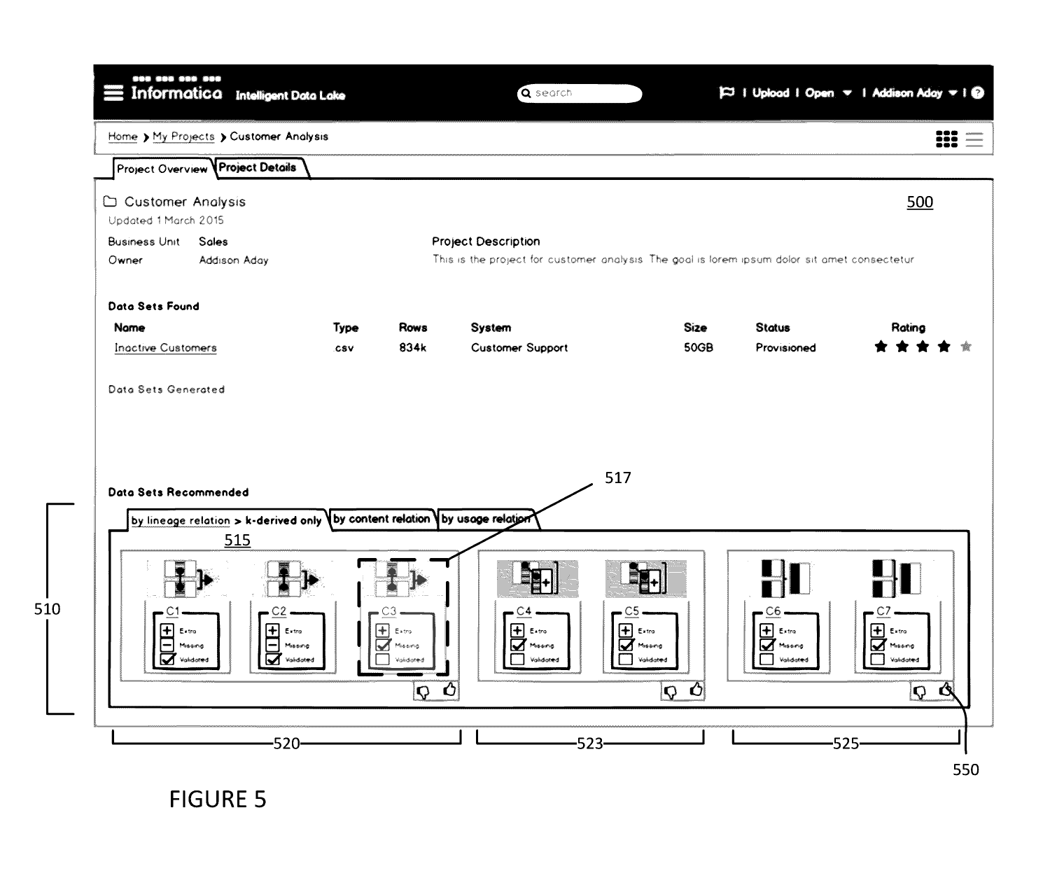

When the user selects (step 345), e.g., group 720 of FIG. 7 via icon 750, this action is processed by recommender system 120 according to the corresponding user actions in Table 1 and the decision tree for the content-based relationships stored in the knowledge base 130. Recommender system 120 then generates a further set of recommendations within the content relationship type, but now categorized by related data. The result is presented (340) in user interface 800 of FIG. 8, which narrows the recommender bar 810 to two groupings of datasets 820 (C1-C4), 825 (C5-C7) with a content relation and further that are related data, as indicated in updated tab 815.

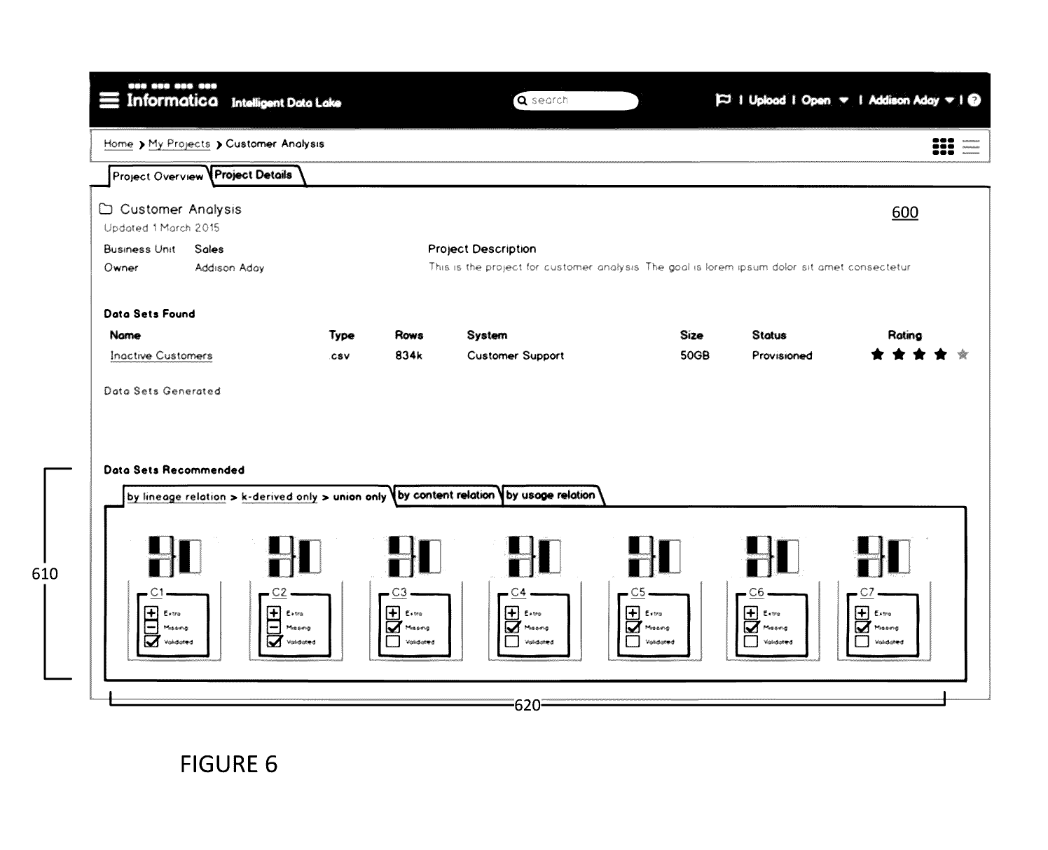

Continuing with FIG. 8, the user interface 800 receives a user selection (340) of the same content lineage relation by clicking on the thumb-up icon 850 for the left most group 820. This action is processed by recommender system 120, which generates a further set of recommended datasets 920 that are all of the same content type, resulting in the recommender bar 910 of user interface 900 of FIG. 9

In yet another example, recommender system 120 receives a user selection of the social relation tab 415c. The result is shown in the user interface 1000 of FIG. 10, which displays a third set of recommendations 1020 (C1-C4), 1025 (C5-C7) in the recommender bar 1010, categorized in two groups by social relationship (shown by tab 415c).

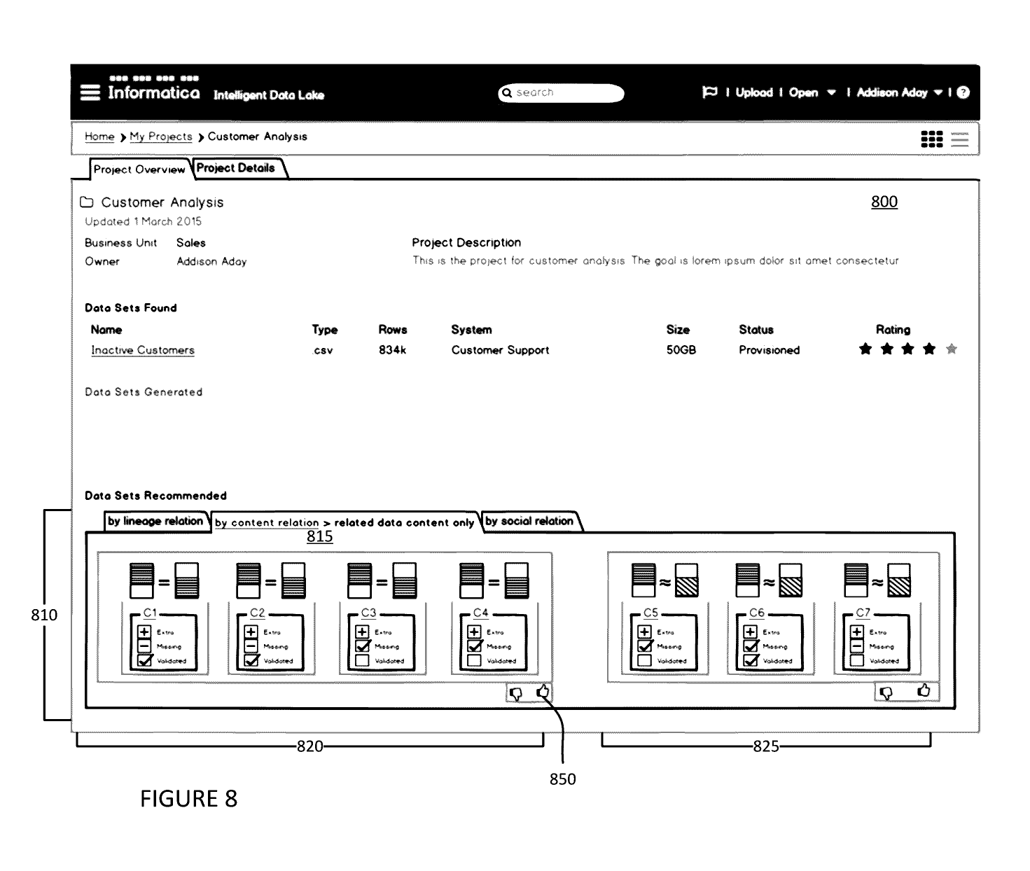

When the user selects (step 345), e.g., group 1020 of FIG. 10 via icon 1050, this action is processed by recommender system 120 according to the corresponding user actions in Table 1 and the decision tree for the social-based relationships stored in the knowledge base 130. Recommender system 120 then generates a further set of recommendations within the social relationship type, but now categorized by org chart ties. The result is presented (340) in user interface 1100 of FIG. 11, which narrows the recommender bar 1110 to two groupings of datasets 1120 (C1-C4), 1125 (C5-C7) with a social relation and further that are org chart ties, as indicated in updated tab 1115.

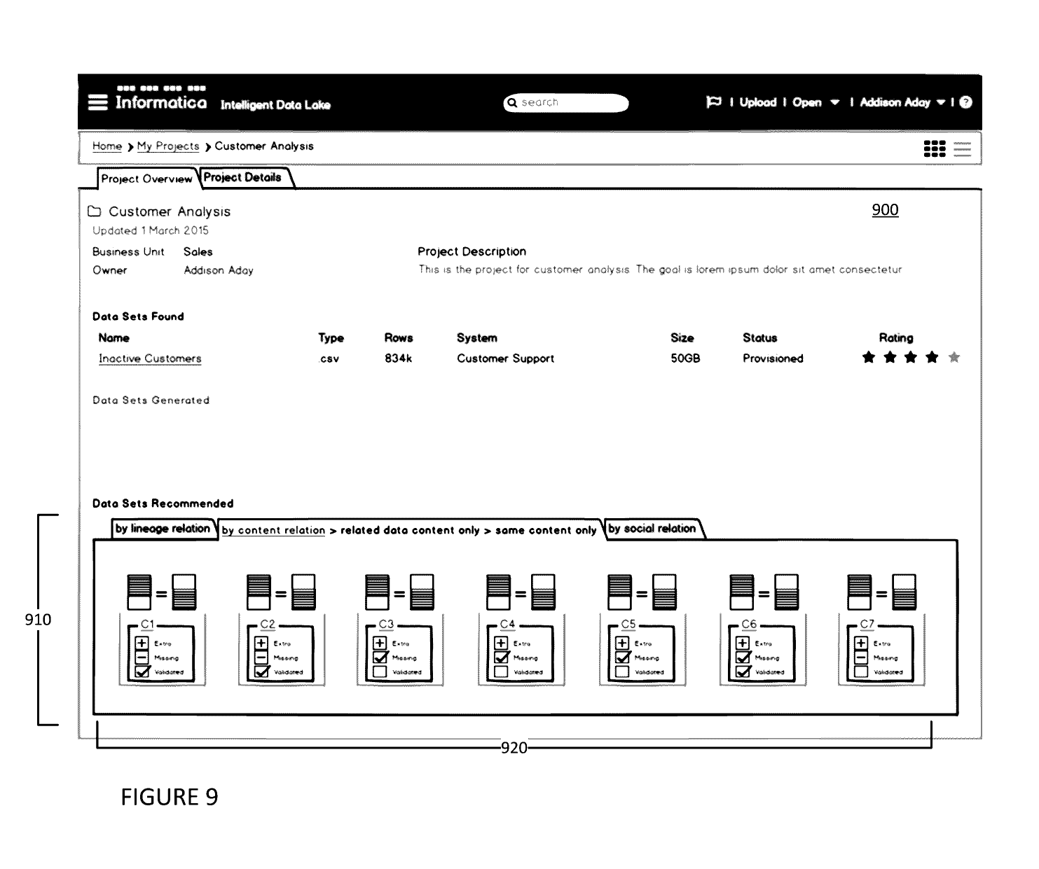

Continuing with FIG. 11, the user interface 1100 receives a user selection (340) of the department relation by clicking on the thumb-up icon 1150 for the left most group 1120. This action is processed by recommender system 120, which generates a further set of recommended datasets 1220 that are all of the same content type, resulting in the recommender bar 1210 of user interface 1200 of FIG. 12.

Referring again to FIG. 5, at any point, the user can request to preview the contents of a recommended dataset by clicking on the card-like thumbnail, e.g., 527 of each recommendation (C1-C7) in the recommendation bar 510. Referring to FIG. 13, there is an shown an example of a preview 1300 of dataset C3 (517) from FIG. 5. Here the recommended dataset C3 (517) is a prospect for a union with the dataset A already in the project. The preview shows a mapping between the columns of A and the columns of C3. That is, the preview shows, in detail, the data in C3 as related to the data in A, e.g., the matching columns 1310. A brief summary of the preview information is contained in details listed at the bottom of the thumbnail 517 of C3 (e.g., as “Extra” columns, “Missing” columns, and “Validated” columns labels in the thumbnail 517).

In the foregoing discussion, the examples provided regarding data sets pertaining to customers, sales transactions, and the like are merely one example usage domain for the recommender system 120; the recommender system 120 may be used in many other domains, including scientific (e.g., datasets of experimental outcomes), medical (e.g., datasets of treatments and patient outcomes), industrial and engineering (datasets of engineering requirements, materials, performance data), and so forth.

### Measurable Improvements

The methods and systems described herein provide measurable improvements in database access technology. Multiple types of metrics can measure the improvement that the method and system provide to the technology underlying current applications for data transformation or preparation by data professionals (e.g., data analysts, data scientists, and ETL developers), as follows.

The first two types of metrics can be computed at the level of individual users or individual user's tasks. The first type of metric is the time taken by a data professional to find the relevant datasets and thus complete the analysis. This includes global user performance metrics such as “average time to complete the analysis” or more specific user performance metrics such as “average time to find a 2nd dataset as soon as a 1st dataset has been found.” The second type of metric is the average quality of the datasets found. This can be measured objectively through per-dataset relevance metrics (see relationships algorithms in this method) applied to all the datasets used when the analysts relied vs. did not rely on the proposed method and system. Alternatively, it can be measured subjectively via ratings by the users on the dataset used (e.g., prompted user feedback).

In addition, other improved metrics can be computed at the level of organizations or community of users over a period of time. One metric in this category is the rate of reuse of datasets across the members of the community (expected to increase with the proposed method and system). This can be computed as one measure of central tendency (percentage over all dataset, mean, mode, or median) or as the detailed distribution of values (see skewedness of distribution). Another metric in this category is the rate of duplication of datasets across the members of the community (expected to increase with the proposed method and system). This can be computed as one measure of central tendency (percentage over all dataset, mean, mode, or median) or as the detailed distribution of values (see skewedness of distribution). Yet another metric in this category is the number of requests that the IT department of the organization received from data professionals for datasets even when the dataset requested was available to the data professionals, but there was no recommendation system deployed.

Finally, an added-value metric shows the number of new analyses produced over a period of time due to ready availability of high quality recommendations. This last metric is a corollary of already existing metrics and assumes baseline measures analyses produced over a period of time in absence of the proposed method and system. This final metrics of the “outcome” of the innovation on the overall quality and quantity of the work.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein, the term “module” refers to computer program logic utilized to provide the specified functionality. Thus, a module can be implemented in hardware, firmware, and/or software. In one embodiment, program modules are stored on a storage device, loaded into memory, and executed by a processor. Embodiments of the physical components described herein can include other and/or different modules than the ones described here. In addition, the functionality attributed to the modules can be performed by other or different modules in other embodiments. Moreover, this description occasionally omits the term “module” for purposes of clarity and convenience.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for determining similarity of entities across identifier spaces. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A computer executed method of recommending datasets for data analysis, comprising:
receiving a user selection of a first dataset;
determining a context corresponding to the user selection of the first dataset;
determining, based on the first dataset and determined context, one or more dataset recommenders, each of the one or more recommenders corresponding to a relationship type between datasets;
determining a plurality of second datasets related to the first dataset based on the relationship types;
scoring each of the plurality of second datasets using a relevance ranking algorithm specific to the corresponding relationship type to score the relevance of the of the second dataset to first dataset;
ranking the plurality of second datasets based on the scoring;
selecting a subset of the ranked datasets as the recommended datasets; and
presenting the recommended datasets in a graphical user interface, wherein the recommended datasets are grouped by relationship type to the first dataset.

2. The computer executed method of claim 1, wherein the relationship types comprise relationship types selected from the group consisting of:
a lineage relationship based on ancestor or descendant relationships between datasets;
a content relationship based on semantically similar datasets;
a structure relationship based on structurally compatible datasets;
a usage based relationships based on datasets previously used by relevant classes of users in association with the previously chosen datasets;
a classification-based relationship based on datasets that share one or more classifications with one or more datasets previously chosen by the user; and;
an organizational or social relationship based on social or organizational relationships between users of the datasets.

3. The computer executed method of claim 1, further comprising:
in response to receiving a selection of one or more recommended datasets, providing a second level of recommended datasets, comprising:
determining a second context corresponding to the user selection of the one or more recommended datasets;
determining, based on the one or more recommended datasets and determined second context, one or more dataset recommenders;
determining a plurality of third datasets related to the one or more recommended datasets based on the relationship types;
scoring each of the plurality of third datasets using the relevance ranking algorithm;
ranking the plurality of third datasets based on the scoring;
selecting a subset of the ranked third datasets as the second level of recommended datasets; and
presenting the second level of recommended datasets in the graphical user interface, wherein the second level of recommended datasets are grouped by relationship type to the selected dataset.

4. The computer executed method of claim 1, further comprising:
in response to determining the context corresponding to the user selection of the first dataset, inferring a user goal based on the context for the user selection of the first dataset; and
presenting the inferred user goal in the a graphical user interface.

5. The computer executed method of claim 4, further comprising:
receiving user input adjusting the inferred user goal presented in the a graphical user interface to a replacement goal;
in response to the adjusting:
determining a revised plurality of datasets related to the first dataset based on the replacement goal;
scoring each of the revised plurality of datasets using a relevance ranking algorithm specific to the corresponding relationship type to score the relevance of the of the second dataset to first dataset;
ranking the revised plurality of datasets based on the scoring;
selecting a revised subset of the ranked datasets as a revised set of recommended datasets; and
replacing the recommended datasets in the graphical user interface with the revised set of recommended datasets.

6. The computer executed method of claim 4, further comprising:
receiving user input adjusting the inferred user goal presented in the graphical user comprising rejection of the presented inferred goal.

7. The computer executed method of claim 4, wherein the inferred user goal is based on a class associated with the determined context and actions associated with the class.

8. The computer executed method of claim 4, wherein the inferred user goal is selected from the group consisting of finding a cleaner dataset, enriching the dataset, and integrating datasets.

9. The computer executed method of claim 1, wherein scoring each of the plurality of second datasets further comprises:
within each relationship type, scoring the second datasets of the relationship type by relevance to the first dataset; and
wherein ranking the plurality of second datasets based on the scoring is based on the scoring within each relationship type and a further scoring of the relationship types.

10. The computer executed method of claim 1, further comprising:
generating a preview of contents of a recommended dataset of the presented recommended datasets in the graphical user interface; and
in response to user input selecting the recommended dataset, presenting the preview of the recommended dataset to the user in the graphical user interface.

11. A non-transitory computer-readable memory storing a computer program executable by a processor, the computer program producing a user interface displaying dataset recommendations, the user interface comprising:
a dataset selection control for receiving a user selection of a first dataset;
a recommendation bar for presenting a set of recommended datasets based on the user selection of the first dataset and a determined context for the selection, wherein the recommended datasets are grouped within the recommendation bar by relationship type to the first dataset;
a relationship confirmation control for receiving a selection of one or more of the recommended datasets.

12. The computer program of claim 11, wherein the user interface is further configured by the computer program to:
in response to receiving a selection of one or more of the recommended datasets, presenting a second level of recommended datasets in the graphical user interface, wherein the second level of recommended datasets are grouped by relationship type to the selected dataset.

13. The computer program of claim 11, further comprising:
presenting an inferred user goal in the a graphical user interface, the inferred user goal based on the determined context for the user selection of the first dataset.

14. The computer program of claim 13, further comprising:
in response to receiving user input adjusting the inferred user goal presented in the graphical user interface to a replacement goal, replacing the recommended datasets in the graphical user interface with a revised set of recommended datasets.

15. The computer program of claim 13, further comprising:
in response to receiving user input adjusting the inferred user goal presented in the graphical user interface comprising rejection of the presented inferred goal, replacing the recommended datasets in the graphical user interface with a revised set of recommended datasets.

16. The computer program of claim 11, further comprising:
in response to user input selecting the recommended dataset, presenting a preview of the recommended dataset to the user in the graphical user interface.

17. A computer program product comprising a non-transitory computer readable storage medium having instructions encoded therein that, when executed by a processor, cause the processor to:
receiving a user selection of a first dataset;
determining a context corresponding to the user selection of the first dataset;
determining, based on the first dataset and determined context, one or more dataset recommenders, each of the one or more recommenders corresponding to a relationship type between datasets;
determining a plurality of second datasets related to the first dataset based on the relationship types;
scoring each of the plurality of second datasets using a relevance ranking algorithm specific to the corresponding relationship type to score the relevance of the of the second dataset to first dataset;
ranking the plurality of second datasets based on the scoring;
selecting a subset of the ranked datasets as the recommended datasets; and
presenting the recommended datasets in a graphical user interface, wherein the recommended datasets are grouped by relationship type to the first dataset.

18. The computer program product of claim 17, further comprising instructions encoded therein that, when executed by the processor, cause the processor to perform steps comprising:
in response to receiving a selection of one or more recommended datasets, providing a second level of recommended datasets, comprising:
determining a second context corresponding to the user selection of the one or more recommended datasets;
determining, based on the one or more recommended datasets and determined second context, one or more dataset recommenders;
determining a plurality of third datasets related to the one or more recommended datasets based on the relationship types;
scoring each of the plurality of third datasets using the relevance ranking algorithm;
ranking the plurality of third datasets based on the scoring;
selecting a subset of the ranked third datasets as the second level of recommended datasets; and
presenting the second level of recommended datasets in the graphical user interface, wherein the second level of recommended datasets are grouped by relationship type to the selected dataset.

19. The computer program product of claim 17, further comprising instructions encoded therein that, when executed by the processor, cause the processor to perform steps comprising:
in response to determining the context corresponding to the user selection of the first dataset, inferring a user goal based on the context for the user selection of the first dataset; and
presenting the inferred user goal in the a graphical user interface.

20. The computer program product of claim 19, further comprising instructions encoded therein that, when executed by the processor, cause the processor to perform steps comprising:
receiving user input adjusting the inferred user goal presented in the a graphical user interface to a replacement goal;
in response to the adjusting:
determining a revised plurality of datasets related to the first dataset based on the replacement goal;
scoring each of the revised plurality of datasets using a relevance ranking algorithm specific to the corresponding relationship type to score the relevance of the of the second dataset to first dataset;
ranking the revised plurality of datasets based on the scoring;
selecting a revised subset of the ranked datasets as a revised set of recommended datasets; and
replacing the recommended datasets in the graphical user interface with the revised set of recommended datasets.

21. The computer program product of claim 17, wherein scoring each of the plurality of second datasets further comprises:
within each relationship type, scoring the second datasets of the relationship type by relevance to the first dataset; and
wherein ranking the plurality of second datasets based on the scoring is based on the scoring within each relationship type and a further scoring of the relationship types.

22. The computer program product of claim 17, further comprising instructions encoded therein that, when executed by the processor, cause the processor to perform steps comprising:
generating a preview of contents of a recommended dataset of the presented recommended datasets in the graphical user interface; and
in response to user input selecting the recommended dataset, presenting the preview of the recommended dataset to the user in the graphical user interface.
